(19) United States
(12) Patent Application Publication
(10) Pub. No.: US 2025/0164661 A1
(43) Pub. Date: May 22, 2025

(54) RECONFIGURABLE ANTENNAS AND ELECTRODES

(71) Applicant: Halliburton Energy Services, Inc., Houston, TX (US)

(72) Inventors: Ahmed Fouda, Houston, TX (US); Baris Guner, Houston, TX (US)

(21) Appl. No.: 18/513,193

(22) Filed: Nov. 17, 2023

(51) Int. Cl. G01V 3/28; E21B 17/02; E21B 49/00

(52) U.S. Cl. CPC G01V 3/28; E21B 17/028; E21B 49/00

(57) ABSTRACT

A programmable and reconfigurable antenna that is equivalent in functionality to a coil antenna and thus capable of performing various measurements based on induction or propagation principles within a wellbore environment.

### BACKGROUND

As part of hydrocarbon recovery operations, a wellbore can be formed in a subterranean formation for extracting produced hydrocarbon material or other suitable material. The wellbore may experience or otherwise encounter one or more wellbore operations such as drilling the wellbore. Drilling, or otherwise forming the wellbore can involve using a drilling system that can include a drill bit and other suitable tools or components for forming the wellbore. During drilling, the drilling system may change the course (e.g., speed, direction, etc.) of the drill bit to form a wellbore that may not be purely vertical. In addition, during drilling and/or after the drilling operations have been completed, a variety of sensors may be utilized downhole and at the surface to measure various parameters associated with the wellbore, the formation surrounding the wellbore, and/or material that has been removed from the wellbore.

### BRIEF DESCRIPTION OF THE DRAWINGS

Embodiments of the disclosure may be better understood by referencing the accompanying drawings.

FIG. 1A illustrates a well system in accordance with various embodiments.

FIG. 1B illustrates a wireline system in accordance with various embodiments.

FIG. 2A illustrates a plan view of an antenna configuration in accordance with various embodiments.

FIG. 2B illustrates an electrical schematic of an antenna configuration in accordance with various embodiments.

FIG. 2C illustrates a perspective view of an antenna configuration positioned on a downhole tool in accordance with various embodiments.

FIG. 3A is a perspective view of a single addend in accordance with various embodiments.

FIG. 3B is a perspective view of a plurality addends positioned in a plurality of layers in accordance with various embodiments.

FIG. 4 illustrates a perspective view of an antenna configuration positioned on a downhole tool in accordance with various embodiments.

FIG. 5A illustrates a plan view of an electrically coupled antenna configuration configured to provide an antenna coil equivalent in accordance with various embodiments.

FIG. 5B is a perspective view representing an electrical equivalent of the antenna coil that the configuration of addends in FIG. 5A may be arranged to provide.

FIG. 6A illustrates a plan view of an electrically coupled antenna configuration configured to provide an antenna coil in accordance with various embodiments.

FIG. 6B is a perspective view representing an electrical equivalent of the antenna coil that the configuration of addends in FIG. 6A may be arranged to provide.

FIG. 7A illustrates a plan view of an electrically coupled antenna configuration configured to provide an antenna coil in accordance with various embodiments.

FIG. 7B is a perspective view representing an electrical equivalent of the antenna coil that the configuration of addends in FIG. 7A may be arranged to provide.

FIG. 8A illustrates a perspective view of an electrically coupled antenna configuration configured to provide an antenna coil in accordance with various embodiments.

FIG. 8B is a perspective view representing an electrical equivalent of the antenna coil that the configuration of addends in FIG. 8A may be arranged to provide.

FIG. 9A illustrates a plan view of an electrically coupled electrode configuration in accordance with various embodiments.

FIG. 9B is a perspective view representing an electrical equivalent of the electrode that the configuration of addends in FIG. 9A may be arranged to provide.

FIG. 10A illustrates a plan view of an electrically coupled electrode configuration configured in accordance with various embodiments.

FIG. 10B is a perspective view representing an electrical equivalent of the electrode that the configuration of addends in FIG. 10A may be arranged to provide.

FIG. 11A illustrates a plan view of an electrically coupled electrode configuration in accordance with various embodiments.

FIG. 11B is a perspective view representing an electrical equivalent of the electrode that the configuration of addends in FIG. 11A may be arranged to provide.

FIG. 12A illustrates a plan view of an electrically coupled electrode configuration in accordance with various embodiments.

FIG. 12B is a perspective view representing an electrical equivalent of the electrode that the configuration of addends in FIG. 12A may be arranged to provide.

FIG. 13 is a flowchart illustrating a method in accordance with various embodiments.

FIG. 14 illustrates a block diagram of an example computer system that may be employed to practice the concepts, methods, and techniques as disclosed herein, and variations thereof.

The drawings are provided for the purpose of illustrating example embodiments. The scope of the claims and of the disclosure are not necessarily limited to the systems, apparatus, methods, or techniques, or any arrangements thereof, as illustrated in these figures. In the drawings and description that follow, like parts are typically marked throughout the specification and drawings with the same or coordinated reference numerals. The drawing figures are not necessarily to scale. Certain features of the invention may be shown to be exaggerated in scale or in somewhat schematic form, and some details of conventional elements may not be shown in the interest of clarity and conciseness.

### DETAILED DESCRIPTION

The description that follows includes example systems, methods, techniques, and program flows that embody embodiments of the disclosure. Unless otherwise specified, use of the terms “connect,” “engage,” “couple,” “attach,” or any other like term describing an interaction between elements is not meant to limit the interaction to a direct interaction between the elements and may also include an indirect interaction between the elements described. Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

Embodiments of a programmable and reconfigurable antenna that is equivalent in functionality to a coil antenna and thus capable of performing resistivity measurements based on induction or propagation principles are described. Embodiment of the disclosed antenna have a mesh of conducting unit cells in a lattice structure, preferably overlaid on a flexible printed circuit board (PCB), that have controllable connections allowing the structure of the antenna to be changed electronically. Each of the individual unit cells will be referred to as addends (i.e., parts of a sum) and the overall system will be referred to as an antenna configuration in this disclosure. Thus, depending on the environmental conditions and the needs of a particular job, parameters of the sensing system such as the spacing between transmitters and receivers, number of turns in the antennas and the tilt angle of the antennas may be electrically adjusted. As a result, properties of the sensing system may be optimized for the environmental conditions. Furthermore, described systems allow the configurations of antennas to include tilted antennas that are electronically steerable. Tilted antennas are used in Log-While-Drilling (LWD) systems to obtain azimuthal sensitivity by utilizing the rotation of the drill string. An equivalent implementation in wireline or permanent monitoring applications of an azimuthally sensitive system utilizing tilted coil antennas require cumbersome, error-prone and relatively expensive mechanically rotating platforms. Described sensor design would provide the azimuthal sensitivity in a non-rotating system in a simpler design that is conformal to underlying surface(s), such as a mandrel or a casing. This property may also be used in reservoir monitoring where the configurable antenna may be located outside of a casing within the wellbore. By electronically steering the antenna, a reservoir adjacent to the wellbore may be monitored in a desired direction. In a similar manner, different antennas that have orthogonal polarizations may be obtained using a single configurable antenna. This may, as an example, enable the implementation of a sensor that is equivalent to a triaxial antenna. For enhancing the performance of the configurable antenna, ferrite substrates, or substrates whose magnetic permeability can be adjusted by injecting ferrofluids may be utilized. Configurable antennas may also be reconfigured into a toroid transceiver to facilitate data transfer.

Embodiments of systems as described herein consist of a configurable antenna consisting of conducting addends that may be printed on a printed circuit board (PCB) or boards. Preferably, the PCB is flexible and thus may be wrapped around a cylindrical surface such as the mandrel. Addends are located on a mesh and connected to neighboring addends through connections that can be activated or deactivated with a control system connected to the PCB. Transistors, which may also be printed/soldered on the same PCB, may be used for this purpose. In various embodiments, the PCB has layers, and each of the addends in a layer may be connected to the one or more addends in another layer. This implementation allows the implementation of radially oriented coil antennas with multiple turns. A control system connected to the PCB may change the selected path of connections in the configurable antennas that are activated. Thus, the properties of the configurable antennas may be changed electronically. This allows, in various embodiments, changing of the orientation, tilt angle, or number of turns of an antenna, as well as the spacing between a pair of antennas. In some cases, a configurable antenna may be reconfigured as a toroid transceiver to facilitate, for example the transfer of data and thus supplement or replace an external telemetry system.

Various embodiments and features of the configurable antenna as described herein include:
A configurable antenna for logging subterranean formations.
May function as coil antennas for induction or propagation logging.
May be implemented using a flexible PCB that may be wrapped on tool mandrel or well casing.
Connections between the addends may be activated electronically to implement reconfigurable sensor systems.
Antennas' orientation, tilt angle and number of turns as well as inter-antenna spacing, for adjustable depth of investigation, may be controlled.
May be used to build azimuthally sensitive systems equivalent to those in LWD that uses the rotation of the drill string.
May also be used to obtain azimuthally sensitive reservoir monitoring systems.
May be reconfigured into toroid transceivers for performing data telemetry.

Embodiments as described herein also include apparatus and method of use of electromagnetic sensors that act as coil antennas and operate on induction or propagation principles for oil field applications that enable programmability and reconfigurability of the sensors. The embodiments will enable the adjustment of the sensor properties electronically. This would, for example, enable steering a tilted coil to obtain azimuthal sensitivity without actually requiring a rotating platform. Other possible applications include changing the orientation of the antenna to obtain a sensor that may perform as a triaxial antenna system. A number of turns of the antenna or inter-antenna spacing may also be adjusted electronically based on the needs of a particular job. Configurable antennas may be reconfigured into toroidal transceivers to perform data telemetry as well.

Embodiments of electromagnetic sensors that act as electrodes and operate on capacitive coupling and galvanic principles for oil field applications that enable programmability and reconfigurability of the sensors are described herein. The sensors utilize the addends and switchable connections as described above with regard to the configurable antennas, which enable the adjustment of the sensor properties electronically. This would, for example in various embodiments enable changing the dimensions of electrodes, inter-electrode spacing and the number electrodes electronically. Thus, adjusting tool's resolution, depth of investigation, number of modes (simultaneous measurements) and signal-to-noise ratio (SNR) would be possible. Configurable electrodes may also be reconfigured into toroidal transceivers to perform data telemetry. Various embodiments and features of the configurable antenna as described herein include:
A configurable electrode system for logging subterranean formations.
May function as electrodes for laterolog, micro focused logging and resistivity imaging applications.
May be implemented using a flexible PCB that may be wrapped on a tool mandrel or well casing.
Connections between the addends may be activated electronically to implement reconfigurable sensor systems.
Electrodes' number, size and spacing may be adjusted according to the requirements of a particular job including resolution, depth of investigation, required number of modes, and signal-to-noise ratio (SNR).
May be reconfigured into toroid transceivers for performing data telemetry.

### Inductive Logging

Induction logging tools utilize alternating, looping current sources to induce eddy currents in the formation. The secondary magnetic fields induced by these eddy currents then creates a voltage on a receiver, which is measured. Traditionally, transmitters and receivers are built using coil antennas. The strength of the secondary magnetic fields is proportional to the conductivity of the surrounding formation. In traditional setups, both the transmitter coils and the receiver coils are wrapped around a mandrel. The current loops can be approximated as magnetic dipoles and the strength of the magnetic moment of the dipoles is proportional to the total area surrounded by the coils. Thus, it is preferable to use a large number of turns for both the transmitter and the receiver to increase the strength of the fields. The direction of the magnetic moment is perpendicular to the surface bounded by the coil (along the axis of the mandrel for this example). Note that the receiver measures not only the secondary fields generated due to eddy currents, but the primary field generated by the transmitter as well. In practice, the primary field is much stronger than the secondary field. To reduce the primary field and to increase the sensitivity to the secondary field, bucking receiver coils may be used. Main receiver coils and the bucking receiver coils are connected, and the bucking receiver coils are wound in an opposite direction to the main receiver coils. The combined field is adjusted by changing the location and/or the number of turns of the bucking and main receivers such that in a controlled environment with low conductivity (such as air), the total field is zero.

In practice, a formation is not necessarily homogeneous. A layered formation model is thus closer to the reality and much more informative. To be able to resolve information corresponding to different formation layers, which may be vertical and/or radial, induction tools that are multi-frequency and multi-spacing are used. An inversion process may be used to determine the formation layers from the measurements made by the receiver coils at different frequencies and/or spacings. In its most simple form, an inversion process tries to find the formation model that best explains the measurements obtained by the tool. Inversion uses a forward model that has formation model (properties of the formation that is relevant to its response, e.g., position of formation layers and their corresponding resistivities) as well as other parameters such as tool position and configuration etc. as its inputs. Here, the forward model should not be confused by the formation model. Forward model relates the aforementioned inputs to the measurements obtained by the tool. Forward model may be an analytical or a numerical solution of the underlying electromagnetic equations. Many commercial programs for performing numerical electromagnetic modelling exists. These programs may use methods such as the finite difference time domain method (FDTD), finite element method (FEM) or the method of moments (MoM).

Thus, inversion may try to find the solution to the equation shown in:

$$arg {min}_{{X}^{=}} ‖ {{V}^{=}}_{meas} - {{V}^{=}}_{model} ( {X}^{=} ) ‖ \qquad Equation 1$$

In this equation, V̅ₘₑₐₛ refers to the measurements made by the tool (which may be a matrix of measurements at different frequencies, different spacings, different logging positions etc. as indicated by the double overbars), V̅_{model} is the predicted measurements by the forward model and X̅ is the matrix of input parameters for the forward model. Double bars refer to the norm operation. Thus, inversion in its most basic form finds the parameter set whose forward model response best matches the measurements. In most cases, additional regularization terms are added to the so called cost function shown in Equation 1 to ensure the smoothness of the response, to incorporate known relationships between forward model parameters etc. Inversion may be performed using iterative methods known in the literature such as the Levenberg-Marquardt method. Most programming languages have readily available optimization packages that can perform inversion with a variety of different methods. In other cases, inversion may be performed using a brute force search method or using a scholastic approach.

Embodiments of the traditional tool as described above do not have azimuthal sensitivity. To obtain azimuthal sensitivity and better determine properties of dipping layers including dip azimuth and dip strike angles, multi-component induction tools may be used. In a multi-component induction tool, coils may be wrapped in directions such that different directions of the magnetic moment that may be orthogonal to one another and that may span the whole space are obtained. Both the transmitter and receivers may be multi-component. By firing different transmitters and recording the responses at each receiver, a total of nine measurements may be made as shown in Equation 2 as follows:

$$[ \begin{matrix}{V}_{xx} & {V}_{xy} & {V}_{xz} \\ {V}_{yx} & {V}_{yy} & {V}_{yz} \\ {V}_{zx} & {V}_{zy} & {V}_{zz}\end{matrix} ] \qquad Equation 2$$

In this equation, Vᵢⱼ refers to the voltage measured at the j-directed receiver due to an i-directed transmitter. Multi-component antennas in other ways operate very much in the same way with the single axis antennas described before. They may include bucking receiver coils, they may operate at multiple frequencies and spacings, and an inversion scheme as described may be utilized to resolve formation parameters.

In various embodiments, the frequency of the induction tools that are used in wireline logging are in the kHz range. At higher frequencies, dominant mechanism becomes propagation rather than induction. In logging-while-drilling (LWD) applications, tools that operate on propagation principles are preferable. This is due to the non-linear and varying effect of the steel drill string that is generally used during drilling on the measurements. At these higher frequencies in the MHz range required for propagation measurements, effect of the formation permittivity becomes important. Thus, the received signal can no longer be considered in-phase with the transmitted signal. In other words, measurement becomes complex rather than real. In propagation measurements, change of the amplitude and phase of the measured signal between two receiver coils is recorded and used to resolve formation properties. Tilted antennas may be used to obtain directionality in LWD systems. Since the drill string rotates during drilling at an angular velocity of @, measurements corresponding to different azimuthal positions may be recorded. Azimuthal positions may be divided into bins. For example, there may be 30 bins corresponding to a span of 12° each. Generally, for each bin, measurements from multiple rotations are averaged together to reduce noise and ensure that a measurement is available for each bin (since a constant angular velocity may not always be maintained). In practice, a combination of tilted and axially-directed transmitters and/or receivers may be used.

A metric called the geosignal may be obtained by subtracting from each bin the measurement from the bin exactly opposite of it (at a 180° angle). It is common to denote bins as “up” and “down” when using geosignal. This up and down definition is customary and would be with respect to an azimuthal reference on the tool. In a homogeneous or symmetric formation, such a geosignal will not be changing with azimuth. However, if there is a difference in the resistivity of the up and down layers, the azimuthal bins that point to the layer with lower resistivity will read lower. It should be mentioned at this point that, in reality, there can be many layers in the up and down direction. These layers may be tilted or anisotropic, etc. There may also be inhomogeneities in the layers such as fractures. However, tool would be mostly sensitive to the properties of a region around the drill string whose dimensions are proportional to tool's depth of investigation. Thus, measured resistivity may in fact be an effective resistivity that includes contributions from many such layers and features. For this reason, measured resistivity is generally denoted as the apparent resistivity. Tilted coils can be used to obtain a multi-component antenna system for a wireline application as well but in those applications orthogonal antennas are preferred since they do not require mechanical rotation and vector decomposition to obtain signals in orthogonal directions.

### Micro Focused Logging Tools

Micro focused logging tools use the principle of spherical focusing in a compact setup in order to make shallow measurements around the borehole. An ideal electrode device in a homogeneous medium would create spherical equipotential surfaces around it. However, the presence of the borehole disrupts the equipotential surfaces and make them elongated along the borehole axis. In spherical focusing, additional bucking (or guard) electrodes are used to maintain spherical equipotential surfaces. In micro focused logging tools, main electrode and guard electrodes are located close to each other to obtain a shallow depth of investigation. Guard electrodes also serve the purpose of focusing current into the formation, thus reducing the effects of the borehole rugosity on the measurements. In a typical micro focused logging tool, at least 90% of the received signal comes from within 2 to 4 inches of the current emitting electrode. These electrodes are located on a pad that is pressed against the borehole wall which further ensures the signal coming mainly from the invaded zone. In fact, it is common practice to label measurements of the micro focused logging tool as Rxo; that is the resistivity of the invaded zone.

### Resistivity Imager Tools

Resistivity imagers operating in water based mud environments may obtain an image of the formation surrounding the borehole based on Galvanic principles. Generally, to obtain an image of the formation and to maximize the borehole coverage, wireline resistivity imagers contain multiple pads. These pads are pushed to the borehole wall by mechanical arms to minimize the effect of rugosity on the images. A multitude of button electrodes are located on each pad to increase the resolution of the tool. Some of the common numbers in industry for the number of pads is 6 or 8 while the number of button electrodes may be between 20 and 30. In various embodiments, two sets of pads that are offset in the axial direction in order to maximize the borehole coverage over a wider range of borehole radii may exist.

During operation, current is emitted by the button electrodes. Pad body also emits current to focus the currents of the button electrodes into the formation. In some cases, portion of the tool's mandrel may also emit current to improve focusing. This current traverses through the mud and formation and ends up at the return electrode. Note that focusing aims to eliminate the direct path between the button electrodes and the return electrode through the conductive mud. For resistivity imagers operating in water based mud environments, return electrode is generally located on the mandrel. An impedance is calculated by measuring the current emitted by each button electrode as well as the voltage between each button electrode and the return electrode. These tools generally operate in the kHz range so capacitive and inductive effects may be ignored. Since the water based mud is highly conductive, the measured impedance is primarily coming from the formation and due to the low frequencies employed by the tool, impedance is mostly real. Thus, mud effect is generally negligible in water based mud environments.

Design of oil based mud resistivity imagers have many similarities to water based mud resistivity imagers. However, additional design considerations should be taken into account for this type of resistivity imagers to account for the highly nonconductive oil based mud. There may be variations between the designs or operating principles of different imagers. In most modern oil based mud resistivity imagers, similar to the water based mud resistivity imager discussed above, a voltage difference between the button array and the return electrodes is applied, which cause currents to be emitted from the button array into the mud and the formation. However, the return electrodes are located on the pad to better focus the currents. Furthermore, oil based mud resistivity imagers operate at higher frequencies than water based mud resistivity imagers to overcome the resistive mud through capacitive coupling. Otherwise, the galvanic conduction process used in water based mud resistivity imagers would be blocked by the mud that exist between the electrodes and the borehole wall since the contact is never perfect due to effects like borehole rugosity and the mismatch between the pad's curvature and the borehole wall. There may be a guard electrode around the button array that is at the same potential with the button array that helps focus most of the current into the formation radially. A pad may be covered with a metal plate called the housing. This housing may be connected with a mechanical arm to the mandrel. The arm may open and swivel to maintain a good contact with the formation and minimize the mud effect. An insulating material such as ceramic may be used to fill the remaining portions of the pad.

Resistivity imagers help determine the structural features and stratigraphy of the formation, characterize the rock texture and make facies analysis. In this sense, they serve a purpose similar to actual cores cut from the borehole wall but in a faster and continuous manner compared to traditional coring.

### Laterolog Log Tools and Induction Tools

As an example of the type of laterolog tools the technique for whom the technique may be applied, a background on dual laterolog tools will be given for simplicity. This is not meant to be limiting, technique may be applied to more modern array laterolog tools that contain more electrodes and have more modes of measurement. Dual laterologs operate on a focusing principle that is similar to that of micro focused logging tools. By electrically changing the current emission/return pattern, tool may obtain two different measurements simultaneously (or near simultaneously in some instances). Focusing may be performed in real time in hardware; or may be performed afterwards through processing of the measured data (i.e., software focusing).

With respect to configurable electrodes, in a similar manner as described above with respect to configurable antenna, embodiments of configurable electrodes as described herein may be composed of conductive addends that have programmable connections to other addends, and arranged in a lattice structure or an array. These connection between addends can be activated or deactivated through a control circuitry. Thus, the properties of the electrode may be changed to obtain a sensor that is suitable for a particular application. Connections may use diodes and/or transistors as switches. Connections may be made by utilizing multipin connectors that may also link the electrodes to the power and control circuitry. These further connections may be through the back side of the substrate. The conductive path may electronically be altered in real-time. Thus, the configurable electrode is programmable and reconfigurable. The connections and addends can be printed on a Printed Circuit Board (PCB). PCBs may have layers of laminated conducting and insulating layers. Connections and addends may thus be created by the etching of the conductive layers. Conductive material used in PCBs in some embodiments is copper. A common insulator material used in PCBs is FR-4. Multilayer PCBs may be used to obtain a configurable electrode consisting of multiple layers laid on top of each other. In such an implementation, addends would also be connected to the neighboring addends in underlying layers.

It should be noted that the addends, elements of the individual structure, are not excited individually and only function when they are located on an activated conductive path. A voltage may be applied between an equivalent transmitting current electrode and an equivalent return electrode. Both the transmitting electrode and the return electrode may be located on the same compartmental electrode in some cases. In other cases, transmitting electrode and return electrode may be located in separate compartmental electrodes. In yet other cases, one of the transmitting or the return electrode may be a traditional, fixed electrode. For example, return may be located on the tool body. It would be appreciated that such an application of the configurable electrodes would still fall under the scope of this disclosure. In some embodiments, configurable electrodes may be used to obtain equivalent monitor electrodes as well. These are electrodes that are just used to measure the voltage. As mentioned, electrodes may be used in either low frequencies where they would operate in a static or quasi-static regime or at higher frequencies where they would operate based on capacitive principles. In the former, a direct conduction will be the dominant phenomenon and the imaginary part of the conductivity may be neglected. In the latter, displacement current will be the dominant phenomenon. Configurable electrodes differ from traditional antenna arrays in that traditional antenna arrays consist of individual antennas which may all be excited with a different amplitude and phase which, in addition to the geometric pattern of the antennas, may be used to obtain a desired radiation pattern in the transmitting mode while in the receiving mode each of the signals of the individual antennas are weighed by a suitable amplitude and phase. Thus, the described configurable electrodes do not constitute an antenna array but a sensor system whose structure may be modified electronically.

There have also been tools for electrical capacitive volume tomography applications where adaptive capacitive plates are used. These plates are excited individually and the magnitude or the phase of each plate is changed according to the desired sensitivity pattern. Furthermore, these capacitive plates do not have direct conductive connections that may be turned on or off as described in this disclosure. Finally, the individual addends in this disclosure that are connected are excited by the same voltage. In those respects, the described sensor systems differ from the adaptive capacitive plates.

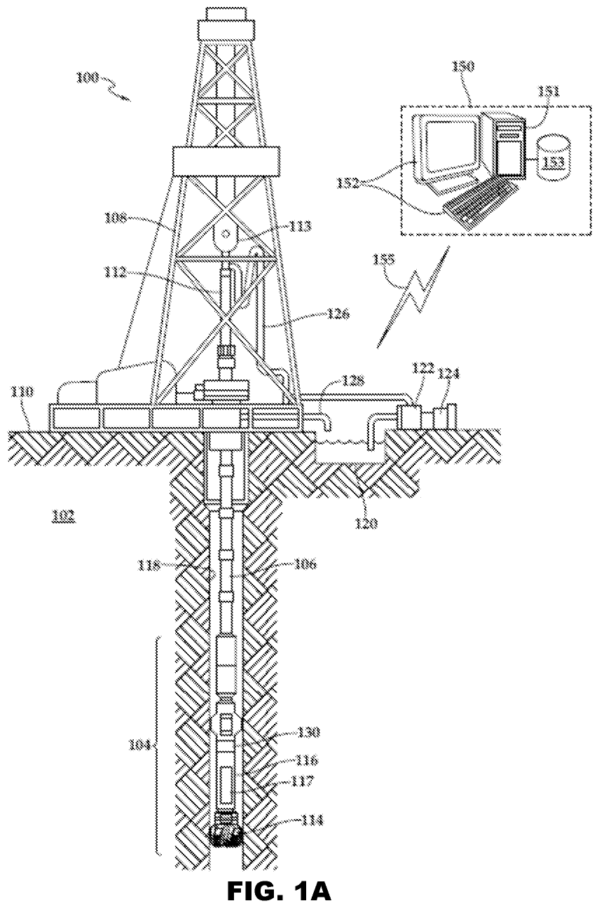

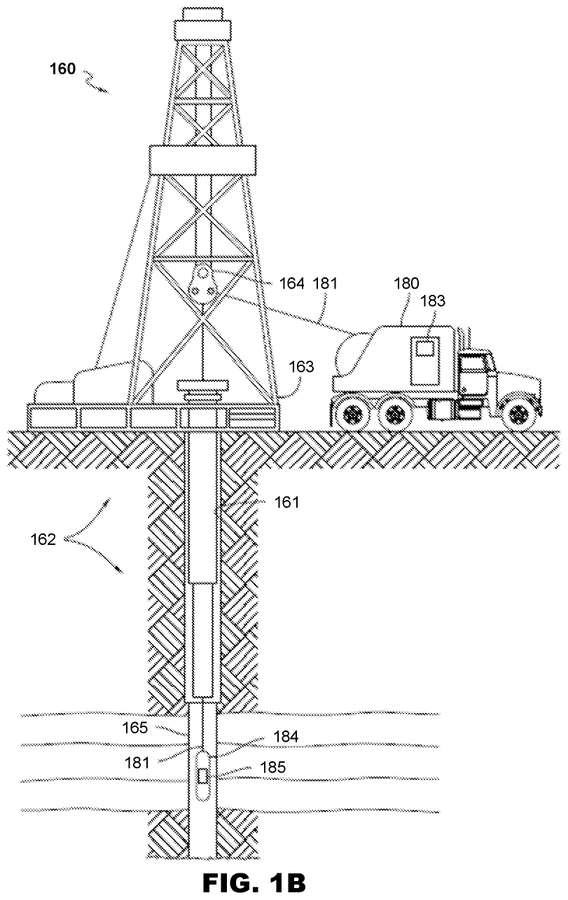

FIG. 1A illustrates a well system 100 in accordance with various embodiments. Well system 100 is configured to include and use the configurable antennas as described herein for the purpose of testing one or more conditions downhole within a wellbore as part of a wellbore drilling operation. The resultant information may be utilized for various purposes, such as for modifying a drilling parameter or configuration, such as penetration rate or drilling direction, in a measurement-while-drilling (MWD) and a logging-while-drilling (LWD) operation. Well system 100 may be configured to drive a bottom hole assembly (BHA) 104 positioned or otherwise arranged at the bottom of a drill string 106 extended into the formation 102 from a derrick 108 arranged at the surface 110. Derrick 108 may include a kelly 112 and a traveling block 113 used to lower and raise kelly 112 and drill string 106. Although shown as a vertical wellbore, embodiments of a wellbore included in well system 100 may include portions of a wellbore that extend vertically, horizontally, and/or at some non-vertical and non-horizontal angle relative to surface 101, or any combination thereof. Also, although depicted as a terrestrial based system, embodiments of well system 100 may include systems positioned over a body of water such as a river, lake, sea, or ocean.

BHA 104 may include a drill bit 114 operatively coupled to a tool string 116 that may be moved axially within a drilled wellbore 118 as attached to the drill string 106. During operation, drill bit 114 penetrates the formation 102, and thereby creates wellbore 118. BHA 104 may provide directional control of drill bit 114 as it advances into the formation 102 Tool string 116 can be semi-permanently mounted with various measurement tools 117 such as, but not limited to, MWD and LWD tools, which may be configured to perform downhole measurements of downhole conditions. In various embodiments, the measurement tools 117 include configurable antennas and/or configurable electrodes as described in this disclosure, and may be self-contained within tool string 116. Embodiments of the configurable antennas and configurable electrodes as described herein may also be, or in the alternative be, located in positions other than at the BHA 104, such as locations within the wellbore 118 but above the position of the BHA, and/or at locations above surface 110.

In well system 100, drilling fluid from a drilling fluid tank 120 may be pumped downhole using a pump 122 powered by an adjacent power source, such as a prime mover or motor 124. The drilling fluid may be pumped from the tank 120, through a standpipe 126, which feeds the drilling fluid into drill string 106, which conveys the drilling fluid to drill bit 114. The drilling fluid exits one or more nozzles arranged in drill bit 114, and in the process cools the drill bit. After exiting drill bit 114, the drilling fluid circulates back to the surface 110 via the annulus defined between wellbore 118 and drill string 106, and in the process, returns drill cuttings and debris to the surface. The cuttings and mud mixture are passed through a flow line 128 and are processed such that a cleaned drilling fluid is returned down hole through standpipe 126.

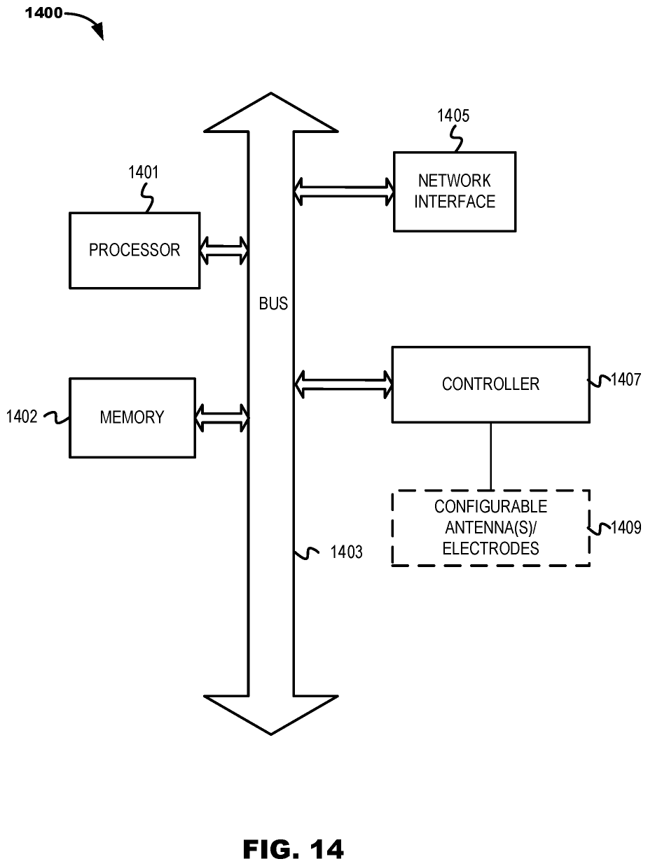

The measurement tools 117 located at tool string 116 or at other locations within wellbore 118 may utilize embodiments that are the same as or similar to the configurable antennas and/or configurable electrodes as described herein More particularly, measurement tools 117 may be configured to transmit signals into the walls of wellbore 118 and/or into the formation materials of formation 102, and/or to received any such transmitted signals for processing in order to gather information about the drilling operation and the surrounding formation. These signals may be generated by a downhole computer system 130 configured to control the generation and transmission of test signals using the configurable antennas and/or configurable electrodes as described herein, to control the configuration of the antenna and/or electrodes themselves, and/or to process the signals received at one or more of the configurable antennas and/or configurable electrodes. The computer memory included as part of the downhole computer system 130 may include instructions that, when operated on by processor(s) of the of computer system 130, control the operations of the configurable antennas in and/or the configurable electrodes in order to perform any of the operations and provide any of the features ascribed to the measurement tools 117. In various embodiments, downhole computer system 130 is configured to communicate with one or more other computer devices, such as user interface 150, which may be located above surface 110, and proximate the site of the wellbore 118, or remotely located from the site of the wellbore. A downhole computer system 130 according to various embodiments may be the computer system as illustrated and described below with respect to FIG. 14.

Referring back to FIG. 1A, embodiments of well system 100 may include a user interface device, as illustratively represented in FIG. 1A by user interface 150. User interface 150 may include a computing device 151, such as a personal computer, a lap-top computer, or some other type of user interface device, such as a smart phone. In various embodiments, user interface 150 includes one or more input/output devices 152, for example a display device such as a computer monitor, which is configured to provide visual display of data and other information related to well system 100 and/or to a fluid treatment process being performed on or modeled for wellbore 118. In various embodiments, the display device is configured to display information regarding data received at user interface 150 from the downhole computer system 130 related to information obtained by measurement tools 117. The computer system of user interface 150 may include one or more additional input devices, such as a computer keyboard, computer mouse, and/or a touch screen that allows a user, such as a technician or engineer, to provide inputs to user interface 150, which may include requests for information regarding the status of well system 100 and/or inputs that may be used to direct the operations of the devices, including devices having a configurable antenna. Connections between user interface 150 and other devices included in in well system 100 may be provided by wired and/or wireless communication connection(s), as illustratively represented by lightning bolt 155.

User interface 150 is communicatively coupled to a non-volatile computer readable memory device 153. Memory device 153 is not limited to any particular type of memory device. Memory device 153 may store instructions, such as one or more applications, that when operated on by the processor(s) of the computing device 151, are configured to control the operations of one or more of the devices included in well system 100. Any combination of one or more machine readable medium(s) may be utilized. The machine readable medium may be a machine readable signal medium or a machine readable storage medium. A machine readable storage medium may be, for example, but not limited to, a system, apparatus, or device, which employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing. Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine. The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

FIG. 1B illustrates a wireline system 160, in accordance with various embodiments. In some embodiments, wireline system 160 may be configured to use a measurement tool 185 that includes one more configurable antenna(s) and/or one or more configurable electrodes as described herein, and any equivalent thereof. As shown in FIG. 1B, after drilling of a wellbore 161, it may be desirable to determine one or more properties associated with the wellbore 161, formation material 162, and/or other structures associated with the well system, through wireline sampling. Although shown as a vertical wellbore, embodiments of a wellbore included in wireline system 160 may include portions of a wellbore that extend vertically, horizontally, and/or at some non-vertical and non-horizontal angle relative to the surface, or any combination thereof. Also, although depicted as a terrestrial based system, embodiments of wireline system 160 may include systems positioned over a body of water such as a river, lake, sea, or ocean.

Wireline system 160 may include a downhole tool 184 that forms part of a wireline logging operation, which may include a downhole measurement tool 185 that utilizes one or more of the configurable antenna(s) and/or one or more of the configurable electrodes as described herein. Wireline system 160 may include a derrick 163 that supports a traveling block 164. Downhole tool 184, which may be a probe or sonde, may be lowered by a wireline cable 181 into wellbore 161 extending into formation material 162.

Downhole tool 184 may be lowered to potential production zone 165 or other regions of interest within wellbore 161, and used in conjunction with other components, such as packers and pumps, to perform well testing and sampling. Downhole tool 184 may be configured to perform any of the functions, and to provide any of the features as described throughout this disclosure ascribed for a tool that utilizes one or more of the configurable antenna(s) and/or one or more configurable electrodes, as described herein, and any equivalents thereof. More particularly, downhole tool 184 may include the measurement tool 185, comprising components configured to perform testing using signals transmitted from and/or received by one or more of the configurable antenna(s) and/or one or more of the configurable electrodes as described herein, and any equivalents thereof. In various embodiments, downhole measurement tool 185 may be configured to measure parameters associated with wellbore 161 and/or other wellbore structure and/or formation material 162, and any measurement data generated by downhole tool 184. In various embodiments, any information associated with these measured parameters can be real-time processed for decision-making, and/or communicated to a surface logging facility 180 for storage, processing, and/or analysis. Logging facility 180 may be provided with electronic equipment 183, including processors for various types of data and signal processing equipment configured to perform at least some steps of the methods consistent with the present disclosure. In various embodiments, electronic equipment may comprise any or all of the components described above with respect to user interface 150. Downhole measurement tool 185 may be configured to perform any of the functions, and to provide any of the features as described throughout this disclosure ascribed for any measurement tool, and/or any equivalents thereof.

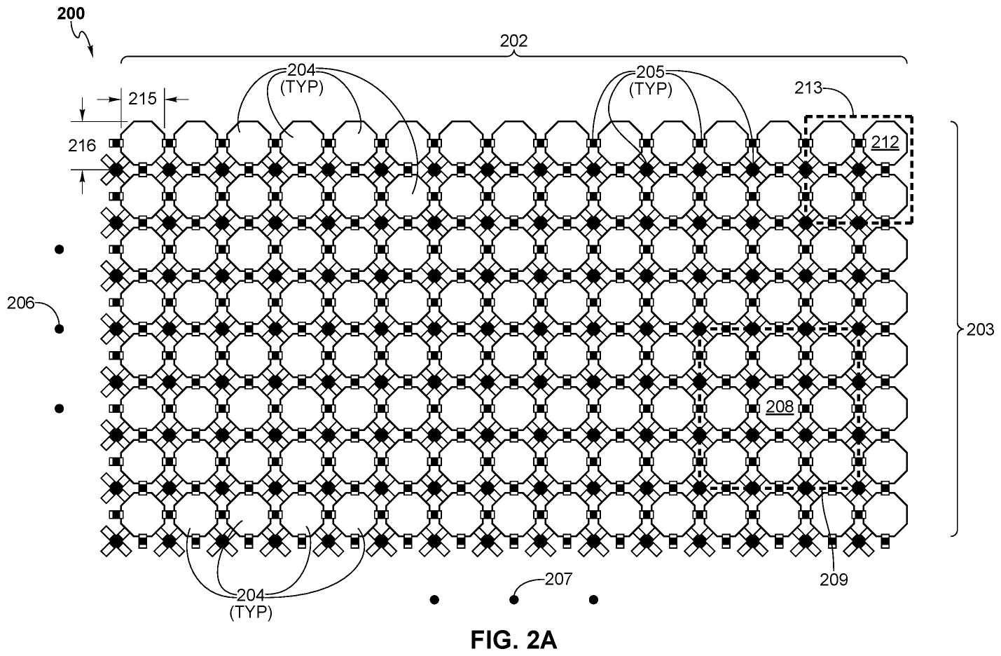

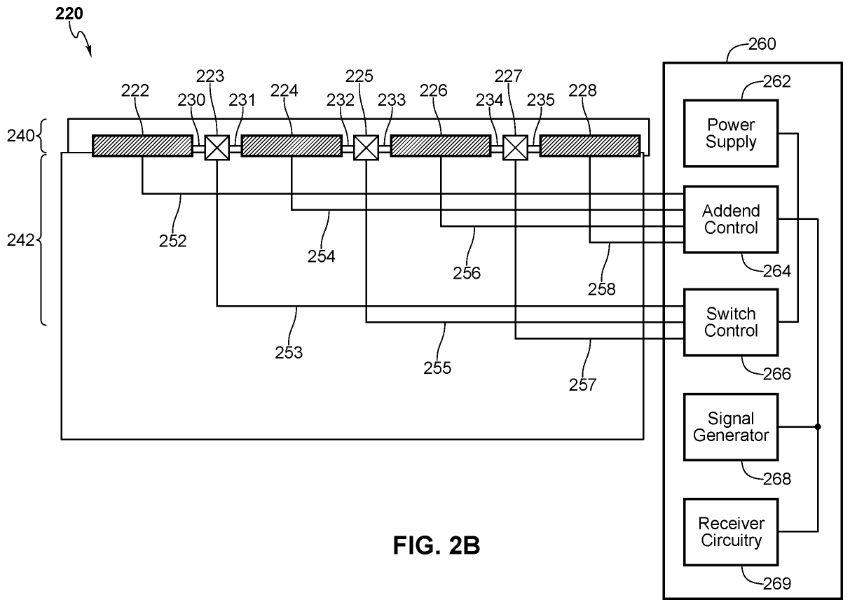

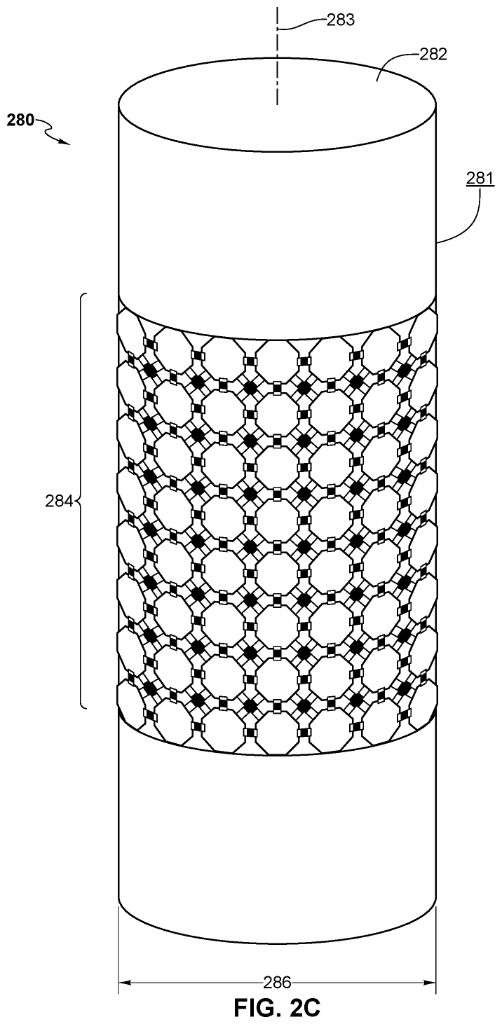

FIG. 2A illustrates a plan view of an antenna configuration 200 in accordance with various embodiments. As shown in FIG. 2A, antenna configuration 200 includes a plurality of addends 204 (typical) arranged in columns 202 and rows 203 to form a grid pattern. Each of addends 204 is formed from an electrically conductive material, such as but not limited to copper, silver, or gold, or some compound that includes any one or a combination of these elements. As shown in FIG. 2A, antenna configuration 200 includes eight rows and fifteen columns of addends, arranged in a rectangular grid arrangement. However, embodiments of antenna configuration 200 are not limited to a particular number of addends arranged in any particular number of rows and/or in a particular number of columns. Embodiments of antenna configuration 200 may include less than eight rows or more than eight rows of addends, as illustratively indicated by dots 206. Further, embodiments of antenna configuration 200 may include less than fifteen columns of addends, or more than fifteen columns of addends, as illustratively represented by dots 207. Further, the physical arrangement of addends within antenna configuration 200 is not limited to a particular shaped grid pattern, such as a square or rectangular shaped pattern, and may include other shapes for the arrangement of the addends, such as but not limited to a round or elliptical shaped arrangement.

As illustrated in FIG. 2A, each of addends 204 is octagonal in shape, having a width dimension 215 and a height dimension 216. However, embodiments of antenna configuration 200 are not limited to having addends 204 with octagonal shapes, and may include addends having a round, square, rectangular, elliptical, or other closed polygonal shape or shapes. Further, as shown in FIG. 2A the width dimension 215 and the height dimension 216 are approximately equal in length. However, embodiments of addends 204 that may be included in antenna configuration 200 are not limited to having a width dimension that is equal to the height dimension, and for example may have one of these dimension that is larger than the other. In various embodiments, a width dimension 215 for an individual addend 204 may range from 0.025 to 25 centimeters (0.01 to 10 inches), and wherein a height dimension for an individual addend 205 may range from 0.025 to 25 centimeters (0.01 to 10) inches. In various embodiments, each of the individual addends 204 has a thickness dimension, such as thickness dimension 241 (FIG. 2B) that may range from 0.0025 to 2.5 centimeters (0.001 to 1 inch(es)).

Referring back to FIG. 2A, each of addends 204 is configured to be controllable to allow the addend to be electrically coupled to one or more other addends 204 that are adjacent to the respective addend through sets of electrical coupling devices 205. By way of illustration, addend 208 as shown in FIG. 2A may be controllably coupled electrically to any one and/or any combination of the eight other addends included within dashed box 209. Further, addend 208 may be controllably disconnected electrically from one and/or any combination of the eight other addends included within dashed box 209. In various configurations addend 208 would be electrically disconnected from all of the other eight addends included within dashed box 209. A same or similar set of controllable configurations applies to any of the addends included in antenna configuration 200 that is positioned within the antenna configuration 200 so as to be adjacent to and directly coupled to eight other addends through a respective set of electrical coupling devices 205. Some of the addends included within antenna configuration 200, are directly coupled to a number of other addends that includes less than eight addends due to their relative positioning within the antenna configuration. For example, addend 212 is only coupled directly through a respective set of electrical coupling devices 205 to three other addends, as shown by the addends included within dashed box 213.

In various embodiments, one or some combination of the electrical coupling devices 205 utilize a diode to provide the electrical coupling between a first addend and a second addend. In such instances, the diode forming the electrical coupling device may allow a flow of electrical current to pass, for example only from the first addend to the second addend but not in the opposite direction from the second addend to the first addend. In various embodiments, one, some combination of, or all of the electrical coupling devices 205 utilize a switchable device, such as a transistor or a solid state relay, which can be controllably turned on and off to provided an electrical connection or no electrical connection between a first addend and a second addend within the antenna configuration that is directly coupled to the respective electrical coupling device. The choice of the type of electrical coupling device 205, and the management and control of the individual electrical coupling devices 205 included in antenna configuration 200, are designed to provide the antenna configuration 200 with a set of overall electrical connections that are designed to provide a particular set of electrical properties for the use of the antenna configuration in order to perform in a desired manner. Examples of various arrangements and control schemes of the addends 204 and electrical coupling devices 205 that may comprise an antenna configuration 200, or some variation thereof, are illustrated and further described below.

FIG. 2B illustrates an electrical schematic of an antenna configuration 220 in accordance with various embodiments. Antenna configuration 220 may be a portion of the antenna configuration 200 as illustrated and described with respect to FIG. 2A, and/or may be representative of the wiring and electrical controls used to control any of the antenna and/or electrode configurations illustrated and described throughout this disclosure, and any equivalents thereof. As shown in FIG. 2B, as set of addends 222, 224, 226, and 228 are arranged in a horizontal row from left to right in the figure, and positioned in an addends layer 240. In various embodiments, electrical connections including control lines as further described below are routed in a wiring layer 242, which may comprise a flexible circuit board. In various embodiments, both the addends layer 240 and the wiring layer 242 are designed to be flexible in order to allow the antenna configuration 220 to be wrapped or otherwise flexed so as to be positionable on a non-flat surface, for example an outer surface of a downhole tool which is cylindrical in shape.

Each of addends 222, 224, 226, and 228 are formed from an electrically conductive material, such as any of the materials described above with respect to addends 204 (FIG. 2A). As shown in FIG. 2B, addends 222, 224, 226, and 228 are directly coupled to one or more adjacent addends through a respective set of electrical conductors and a set of switchable electrical devices. For example, addend 222 is directly coupled to adjacent addend 224 through electrical conductor 230 coupling addend 222 to electrical switching device 223, which in turn is coupled to addend 224 through electrical conductor 231. In a similar manner, as shown in FIG. 2B addend 224 is directly coupled to adjacent addend 226 through electrical conductor 232 coupling addend 224 to switchable electrical device 225, which in turn is coupled to addend 226 through electrical conductor 233; and addend 226 is directly coupled to adjacent addend 228 through electrical conductor 234 coupling addend 226 to switching device 227, which in turn is coupled to addend 228 through electrical conductor 235. As such, antenna configuration 220 is arranged to allow an electrical connection, or to electrically disconnect, any one of addends 222, 224, 226, and 228 from an adjacent addend within the antenna configuration 220.

In various embodiments, control over the electrical connection or disconnection between the addends of antenna configuration 220 is provided through addends configuration controller 260. As shown in FIG. 2B, addend configuration controller 260 includes a power supply 262, addends controller 264, switch controller 266, and in various embodiments a signal generator 268 and receiver circuitry 269. Power supply 262 supplies electrical power that may be used by switch controller 266 to operate and control switching devices 223, 225, 227. Further, power supply 262 may provide electrical energy, that in conjunction with signal generator 268, provides waveforms, such as radio frequency signals, which are applied to one or more of addends 222, 224, 226, 228 through addend controller 264 in order to transmit a signal emulating from the addends based on the applied waveform(s), and/or to power a signal receiver 169 including electrical circuitry configured to receive and process signals that may be received using an antenna formed by some combination of addends 222, 224, 226, and 228.

As shown in FIG. 2B, each of the electrical switching devices 223, 225, and 227 is electrically coupled to the switch controller 266 by respective control lines 253, 255, and 257. Switch controller 266 is configured to control an electrical input, such as a voltage level, which is individually controllable and applied to each of the control lines 252, 255, and 257. Depending on the electrical input provided to a given one of the control lines, the respective electrical switching device (223, 225, 227) coupled to that control line may be switched to an “ON” state that provides an electrically conductive connection between the addends coupled to that particular switching device, or may be switched to an “OFF” state that electrically disconnects the two addends that are coupled to that particular switching device. By way of illustration, a control voltage applied to control line 253 by switch controller 266 may be used to switch the switching device 223 from an “OFF” state to an “ON” state, thereby providing an electrical connection between addend 222 and addend 224. In addition, switch controller 266 may further be configured to provide a control voltage to control line 253 that may be used to switch the switching device 223 from an “ON” state to an “OFF” state, thereby electrically disconnecting addend 222 from addend 224, at least through switching device 223. Similar control signals may be applied by switch controller 266 to control line 255 to electrically connect or disconnect the electrical connection between addend 224 and addend 226 formed through switching device 225, and control line 257 to electrically connect or disconnect the electrical connection formed between addend 226 and 228 formed through switching device 227.

In addition to controlling the connections between addends, addends configuration controller 260 includes an addend controller 264 configured to control the input of signals to and received from the addends 222, 224, 226, and 228. Addend control line 252 electrically couples addend 222 with addend controller 264, addend control line 254 electrically couples addend 224 with addend controller 264, addend control line 256 electrically couples addend 226 with addend controller 264, and addend control line 258 electrically couples addend 228 with the addend controller. Addend control lines 252, 254, 256, and 258 are configured to provide an electrical path for an electrical signal between the addend controller 264 and a respective one of the addends 222, 224, 226, 228 to which the addend control line is coupled. Addend controller 264 is configured to set a status of a control line such that the control line passes an electrical signal to the addend connected to the control line. For example, a waveform generated by signal generator 268 may be coupled by addend controller 264 to addend control line 252, and is thereby applied to addend 222. Addend controller 264 may further be configured to set a status of a control line such that the control line disconnects the addend coupled to the control line from any additional circuitry within the addend controller 264. For example, addend controller 264 may isolate addend control line 254 from any circuitry within addend controller 264, thereby “floating” the addend 224 relative to signals and/or voltages provided by addend controller 264. This “floating” of the addend 224 may be desirable when for example a signal is already being applied to addend 222 by the addend controller 264, and that applied signal is then passed along from addend 222 to addend 224 by actuating switching device 223 to an “ON” state. Because the signal already being applied to addend 222 is being coupled to addend 224, the control line 254 will be operated to disconnect addend 224 from other circuitry coupled to control line 254 within the addend controller 264, thereby “floating” the control line 254.

In addition to floating the addend 224, addend controller 264 may be configured to couple addend 224 through control line 254 as a return or a ground connection. By doing so while switching device 223 is actuated to an “ON” state and while a signal is being applied to addend 222, the addends 222 and 224 provide a configured antenna for transmitting the signal being applied to these two addends, which may also be connected to other addends (not show in FIG. 2B) to form the configured antenna. Switch controller 266 may activate switching device 223 to an “ON” state, thereby coupling addend 222 to addend 224.

In various embodiments, addend controller 264 is configured to couple two or more of addends 222, 224, 226, and 228 together, in some embodiments with additional addends (not shown in FIG. 2B), to form a receiving antenna that is configured to receive signals at the antenna. The received signals may be coupled through addend controller 264 to receiver circuitry 269, where the received signal may be processed (filtered, amplified, decoded) for logging, measurement sensing, and other information gathering activities.

In any of the examples as described above for antenna configuration 220, some or any combination including all of the addends 222, 224, 226, and 228 may be controllably coupled together and/or coupled to additional addends to form a desired arrangement for a configured antenna. In various embodiments, addends configuration controller 260 may be a part of a computer system, such as computer system 1400 (FIG. 14), which may be located in part or as a whole in a downhole location, or above a surface proximate a well system. Addends configuration controller 260 may be configured to communicate with other downhole devices and/or other devices located above a surface adjacent to a wellbore using any type of telemetry, and further described below with respect to user interface 150 (FIG. 1A) and/or computer system 1400 (FIG. 14).

FIG. 2C illustrates a perspective view of an antenna configuration 280 positioned on a downhole tool in accordance with various embodiments. As shown in FIG. 2C, an antenna configuration includes a set of addends 284 positioned on an outer surface 281 of a downhole tool 282. Downhole tool 282 has a generally upright cylindrical shape, with outer surface 281 extending around and encircling a longitudinal axis 283 of the downhole tool. Downhole tool 282 in various embodiments has a diameter 286 that is perpendicular to the longitudinal axis 283 and having a dimension in a range from 5 to 30 centimeters (2 to 12 inches). In various embodiments, downhole tool 282 is formed from a non-electromagnetic material, such as PEEK or FR-4. In alternative embodiments, the downhole tool 282 is formed from an electromagnet material, such as an iron based material.

As shown in FIG. 2C, the set of addends 284 extend around at least a portion of the outer surface 281. In various embodiments, the set of addends 284 extend around the entirety of the outer surface 281 (360 degrees around longitudinal axis 283). In other embodiments, the set of addends 284 extend radially around the outer surface 281 of the downhole tool 282 for less than the full 360 degrees of the tool surface. In various embodiments, the set of addends 284 is coupled to a configuration controller (not shown in FIG. 2C, but for example addends configuration controller 260 of FIG. 2B), and is controllable to operate to perform any of the functions and to provide any of the features described herein for antenna configurations, and any equivalent thereof. As described above, the addends layer and the wiring layers forming the antenna configuration 280 are flexible, allowing the antenna configuration to bend around and be formed to the shape of the outer surface 281 of the downhole tool.

FIG. 3A is a perspective view 300 of a single addend 302 in accordance with various embodiments. As shown in FIG. 3A, addend 302 is positioned within a layer of material 303 and is surrounded by eight electrical connections 310, 311, 312, 313, 314, 315, 316, and 317, which each have a first end in contact with addend 302, and second end that extends away from the addend. Addend 302 is formed from an electrically conductive material, and each of the eight electrical connections are also form from an electrically conductive material such that an electrical signal or electrical voltage level present at the addend is also coupled to each of the electrical connections. Addend 302 also includes an electrical contact 320 that is coupled to the addend, is electrically conductive, and is configured to receive an addend control wire that is electrically coupled to the addend through the electrical contact 320. Electrical contact 320 may receive an electrical signal that is applied to addend 302 through the pad, and/or be configured to provide a return path through the pad for an electrical signal that may be present on addend 302. A control wire that may be coupled to electrical contact 320 may provide an electrical control signal from an addend controller used to apply signals to electrical contact 320, to receive signals from electrical contact 320, and/or to “float” the control wire, and thus electrical contact 320 and addend 302, relative to other circuitry that may be coupled to the control wire. One or more signals that may be present at addend 302 may have been coupled to the addend through one or more of electrical connections 310, 311, 312, 313, 314, 315, 316, and 317, and wherein one or more signals that may be present at addend 302 may be coupled to other addends through one or more of these electrical connections.

FIG. 3B is a perspective view 330 of a plurality addends positioned in a plurality of layers in accordance with various embodiments. As shown in FIG. 3B, a plurality of addends 331 are positioned adjacent to one another in a planar layer 332 of material. In addition to layer 332, additional layers 334, 336, and 338 may be stacked together, wherein each of the additional layers also include a set of addends arranged in a same or similar manner as illustrated for layer 332 and addends 331. For the sake of clarity, the interconnects between addends within a same layer and/or within different layers are not illustrated in FIG. 3B, but would be included as needed to control and provide the interconnections between addends in order to allow the addends to provide any of the features and form any of the antenna configurations as described herein, and any variations thereof.

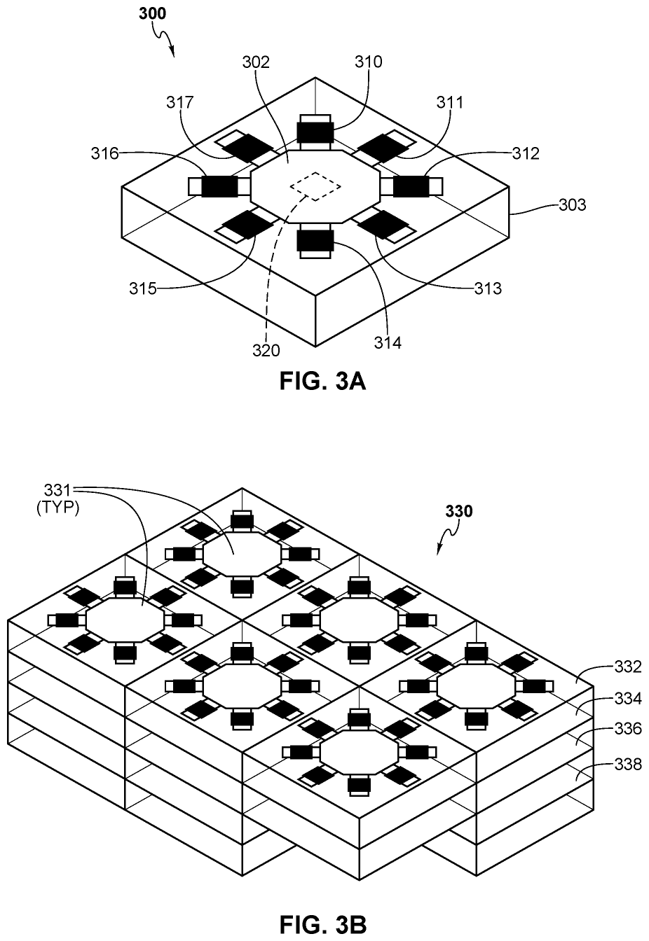

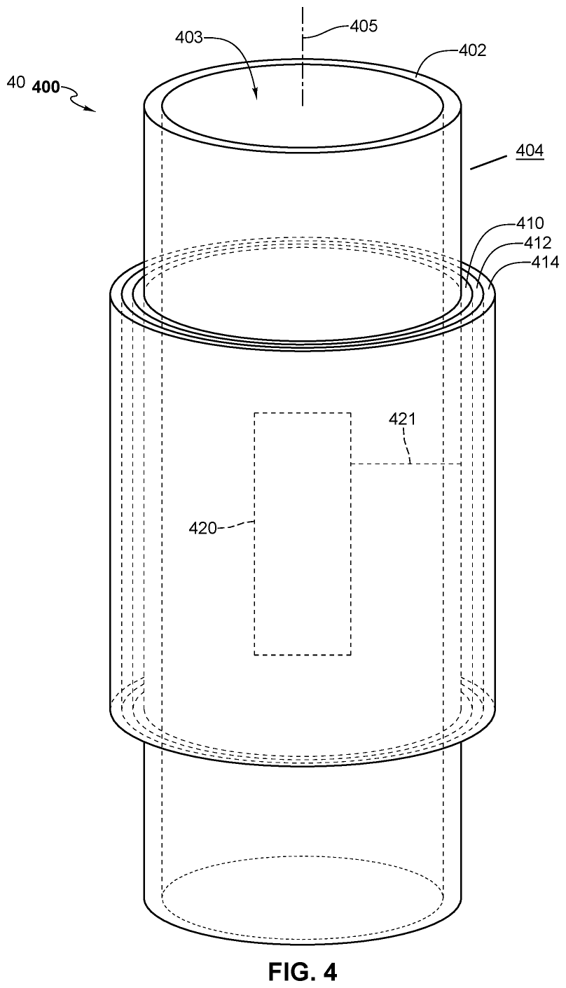

FIG. 4 illustrates a perspective view 400 of an antenna configuration positioned on a downhole tool in accordance with various embodiments. As shown in FIG. 4, an antenna configuration including multiple layers of addends 410, 412, and 414, are positioned on an outer surface 404 of a downhole tool 402. Downhole tool 402 has a generally upright cylindrical shape, with outer surface 404 extending around and encircling a longitudinal axis 405 of the downhole tool. Downhole tool 402 in various embodiments has a diameter that is perpendicular to the longitudinal axis 405 having a dimension in a range from 5 to 30 centimeters (2 to 12 inches). In various embodiments, downhole tool 402 is formed from a non-electromagnetic material, such as PEEK or FR-4. In alternative embodiments, the downhole tool 402 is formed from an electromagnet material, such as an iron based material.

In various embodiments, each of layers 410, 412, and 414 are stacked radially upon one another, each of the layers encircling the longitudinal axis 405 at a different distance radially from the longitudinal axis 405. In various embodiments, each of layers 410, 412, and 414 includes a set of addends that may be arranged as illustrated and described above with respect to FIG. 3B. Referring again to FIG. 4, in various embodiments the inner surface of layer 410 is in contact with the outer surface 404 of the downhole tool, an inner surface of layer 412 is in contact with an outer surface of layer 410, and outer surface of layer 412 is in contact with an inner surface of layer 414. In various embodiments, each of the layers extend around at least a portion of the outer surface 404. In various embodiments, each of the layers 410, 412, and 414 extends around the entirety of the outer surface 404 (360 degrees around longitudinal axis 405). In other embodiments, each of the layers 410, 412, and 414 extends radially around the outside of outer surface 404 of the downhole tool 402 for less than the full 360 degrees of the tool surface. In various embodiments, the set of addends included in layers 410, 412, and 414 is coupled to an antenna controller 420 through electrical connection 421, and is controllable to operate to perform any of the functions and to provide any of the features described herein for antenna configurations, and any equivalent thereof. In various embodiments, antenna controller 420 is located in an internal cavity 403 provided within downhole tool 402. In other embodiments, antenna controller 420 may be located externally relative to downhole tool 402. In various embodiments, the configuration as illustrated in FIG. 4 may be operated as an electrode, for example using outer layer 414, and/or may be operated as a toroid for data telemetry.

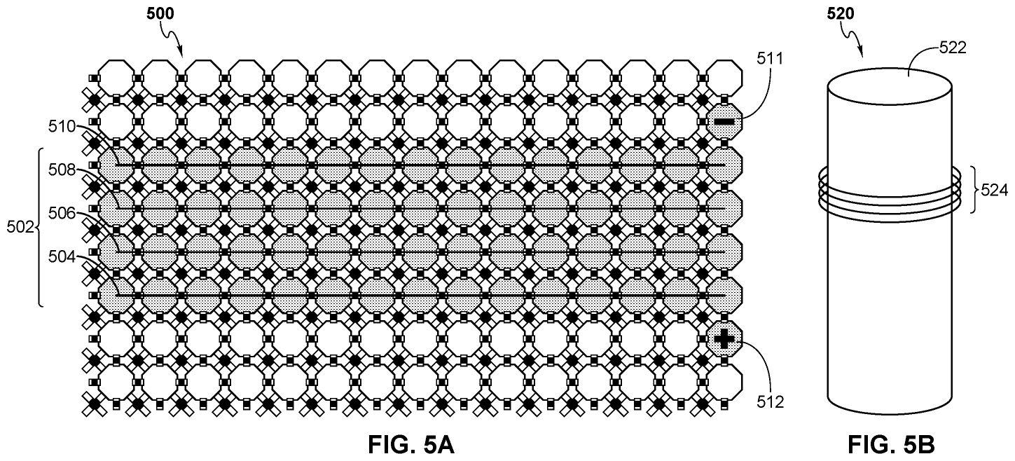

FIG. 5A illustrates a plan view 500 of an electrically coupled antenna configuration configured to provide an antenna coil equivalent, in accordance with various embodiments. FIG. 5B is a perspective view 520 representing an electrical equivalent of the antenna coil that the configuration of addends in FIG. 5A may be arranged to provide. As shown in FIG. 5A, a single addend 512 is designated as the “+” addend, and is coupled at one end point of the antenna coils form by addends 502. Addends 502 include a first row 504 of addends coupled at a first end to addend 512, and coupled together across the row to one another between adjacent addends within the row. An end addend of row 504 is coupled to an end addend of row 596. Row 506 includes a set of addends coupled to one another between adjacent addends within the row, and having an end addend of the row coupled to an end addend of row 508. Row 508 includes a set of addends coupled to one another between adjacent addends within the row, and having an end addend of the row 508 coupled to an end addend of row 510. Row 510 includes a set of addends coupled to one another between adjacent addends within the row, and having an end addend of the row coupled to the single “−” addend 511.

When arranged as described above, the rows of addends 502 of FIG. 5A, when wrapped around a tool body 522 having a cylindrical shape, form a set of antenna coils illustratively represented as antenna 524 in FIG. 5B. When configured as described in FIG. 5A and as arranged in FIG. 5B, the antenna 524 may be configured to have a waveform signal applied to the addends, and to therefore transmit a signal emanating from the antenna 524 formed by the arrangement of the addends. In addition, in the alternative or at different times, antenna 524 may be coupled to a receiver (not shown in FIG. 5A or 5B, but for example receiver circuitry 269, FIG. 2B). and configured to receive signals that arrive at the antenna 524.

A basic implementation of the described structure of FIG. 5A would be equal to a coil antenna whose magnetic moment is directed along the axis of the tool body as shown in FIG. 5B. For the configurable antenna operating in transmitting mode, a voltage from a driving circuit or power supply may be applied between the addend labeled as (+) and the addend labeled as (−). Similarly, when operating in a receiving mode, the voltage between the addends labeled as (+) and (−) may be measured using a measurement circuit or pre-amplifier. In the transmitting mode, an antenna controller coupled to the configurable antenna may include a signal generator (that may generate a sine wave at a given frequency in examples), which may in turn be connected to a power amplifier that may be used to enhance the transmitted signal level. A filter may be connected to the output of the power amplifier to remove undesired frequency components in the signal. The resulting signal may then be applied as the excitation of the configurable antenna at the desired ends of the connection path. In the receiving mode, a received signal obtained from the ends of the conduction path may be filtered and passed through a low noise amplifier. A duplexer may be connected to switch between the transmitting and receiving modes. In various embodiments, the configurable antenna is manufactured using a flexible PCB and wrapped around a cylindrical structure such that the leftmost addends are connected to the rightmost addends. These connections may then be turned on as indicated by the energized connections coupling rows 504, 506. 508 and 510. When wrapped around a cylindrical structure such as a tool body, this configuration would lead to an antenna that is equivalent to a coil antenna in axial direction. Equivalent structure obtained using traditional coil antennas is shown in FIG. 5B. Benefits of the described configurable structure compared to the traditional structure would include the capability of electronically changing of the number of turns of the antenna on demand as well as changing the location of the antenna (and thus, the inter-antenna spacing) to adjust the depth of investigation of the tool as needed.

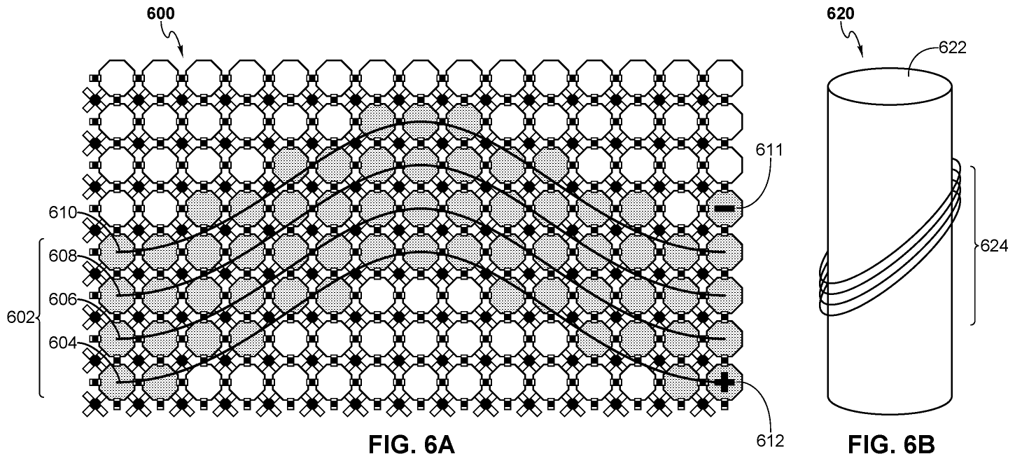

FIG. 6A illustrates a plan view 600 of an electrically coupled antenna configuration configured to provide an antenna coil in accordance with various embodiments. FIG. 6B is a perspective view 620 representing an electrical equivalent of the antenna coil that the configuration of addends in FIG. 6A may be arranged to provide. As shown in FIG. 6A, a single addend 612 is designated as the “+” addend, and is coupled as one end point of the antenna coils formed by addends 602. Addends 602 include a first row 604 of addends coupled at a first end to addend 612, and coupled to together across the row to one another between adjacent addends within the row. However, instead of the coupled and adjacent addends in row 604 being arranged in a perfectly horizontal arrangement, the addends that are coupled together to from row 604 are arranged in a curved shaped arrangement that resembles a sinusoidal wave shape. Row 606 includes a set of addends coupled to one another between adjacent addends within the row, also forming an arrangement of addends having a curved shape resembling a sinusoidal wave shape, and having an end addend coupled to row 604 and having another end addend of the row coupled to an end addend of row 608. Row 608 includes a set of addends coupled to one another between adjacent addends within the row, also forming and arrangement of addends having a curved shape resembling a sinusoidal wave shape and having an end addend of the row 608 coupled to an end addend of row 610. Row 610 includes a set of addends coupled to one another between adjacent addends within the row, also forming an arrangement of addends having a curved shape resembling a sinusoidal wave shape and having an end addend of the row coupled to the single “−” addend 611.

When arranged as described above, the rows of addends 602 of FIG. 6A, when wrapped around a tool body 622 having a cylindrical shape, form a set of antenna coils illustratively represented as antenna 624 in FIG. 6B. When configured as described in FIG. 6A and as arranged in FIG. 6B, the antenna 624 may be configured to have a waveform signal applied to the addends, and to therefore transmit a signal emanating from the antenna 624 formed by the arrangement of the addends. In addition, in the alternative or at different times, antenna 624 may be coupled to a receiver (not shown in FIG. 6A or 6B, but for example receiver circuitry 269, FIG. 2B), and configured to receive signals that arrive at the antenna 624.

When arranged as shown in FIG. 6A, the configurable antennas may be used to obtain structures equivalent to tilted coil antennas that have sensitivity in azimuthal direction in addition to the axial direction. In such instances, the described configurable structure has the benefit of enabling electronic steering; that is, the adjustment of the tilt angle of the antenna electronically. As previously mentioned, tilted coils are used in LWD systems to obtain azimuthally sensitive measurements by using the underlying rotation of the drill string. The arrangement of the configurable antenna of FIG. 6A may allow obtaining multiple measurements from different effective tilt angles to determine formation relative dip as well as formation anisotropy without mechanically rotating a tilted coil. This would be particularly important in wireline applications where tool body does not rotate (unless a specially designed rotating platform is used). Thus, the described configurable antenna would allow making azimuthally sensitive measurements in wireline systems using a conformal antenna that may be simpler to implement than multi-component antennas.

In further examples, these measurements may be utilized to eliminate effects related to formation anisotropy. In comparison to the implementation using traditional coil antenna however, the described configurable structure will not use superposition principles to combine different measurements to obtain an equivalent tilt angle but rather can obtain measurements in the desired tilt angle by the electrical adjustments of the configurable antenna. Thus, it will be less affected from noise artifacts. The intersection of a plane with a cylinder, when cylinder is unwrapped as a plane surface, would give a sinusoidal line. The equivalent tilt angle of the structure, θ, is given by the formula given in Equation 3 where r_{cyl} is the radius of the cylindrical surface and A is the axial displacement of the plane at the edges of the cylinder with respect to its center (i.e., amplitude of the sinusoid).

$$θ = {tan}^{- 1} ( \frac{A}{{r}_{cyl}} ) \qquad Equation 3$$

Thus, as shown in FIG. 6A, by applying a voltage between the addends labeled as (+) and (−) and adjusting the current path such that it follows the curved lines in the direction of the arrow, only the connections between the shaded addends may be turned on and addends shown as shaded may be excited in such a manner that the structure, when wrapped around a cylinder, roughly follows the path of the tilted coil shown in FIG. 6B. Note that addends may be made much finer than those depicted in this figure. Thus, adherence to the sinusoidal variation may be significantly improved in comparison to what is being depicted in the illustration.

In various embodiments, the configurable antenna of FIG. 6A may be installed outside a casing for reservoir monitoring purposes. In this application, the underlying structure shown FIG. 6B where tilted coils are wrapped may be the casing itself. By electronically steering the configurable antenna, information from a wide swath of the formation around the casing may be inspected, and changes in formation properties (such as flooding of formation with water in steam-assisted gravity drainage type applications or monitoring carbon storage reservoirs in CCUS applications) may be detected.

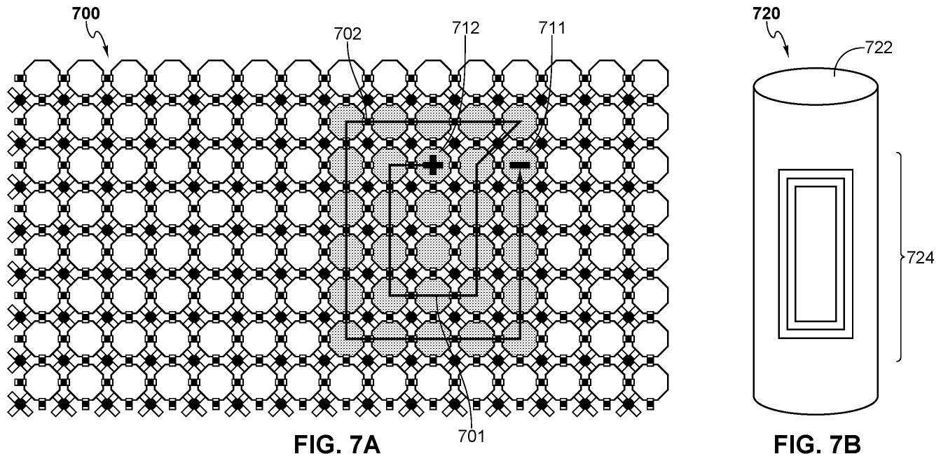

FIG. 7A illustrates a plan view 700 of an electrically coupled antenna configuration configured to provide an antenna coil in accordance with various embodiments. FIG. 7B is a perspective view 720 representing an electrical equivalent of the antenna coil that the configuration of addends in FIG. 7A may be arranged to provide. As shown in FIG. 7A, a single addend 712 is designated as the “+” addend, and is coupled as one end point of a set of addends forming a first loop 701 of an antenna coil that encircles a pair of addends not coupled to any of the addends included in the first loop. A second set of addends are coupled together to form a second loop 702 that encircles the first loop of coupled addends, and wherein the second loop of addends is coupled to the first loop of addends through a single one of the addends including in the first loop. The second loop of addends terminates at a single “−” addend 711. Although shown as including only two loops, embodiment of the arrangement of addends may include additional loops, such as a third loop, that encircles both the first and second loops, which is coupled to the second loop through a single addend included in the second loop, and terminates at the single “−” addend 711 instead of having the second loop terminate at addend 711.

When arranged as described above, the loops 701 and 702 of addends as shown in FIG. 7A, when wrapped around a tool body 722 having a cylindrical shape, form a set of antenna coils illustratively represented as antenna 724 in FIG. 7B. When configured as described in FIG. 7A and as arranged in FIG. 7B, the antenna 724 may be configured to have a waveform signal applied to the addends, and to therefore transmit a signal emanating from the antenna 724 formed by the arrangement of the addends. In addition, in the alternative or at different times, antenna 724 may be coupled to a receiver (not shown in FIG. 7A or 7B, but for example receiver circuitry 269, FIG. 2B), and configured to receive signals that arrive at the antenna 724.

In various embodiments, the configurable antenna of FIG. 7A may be used to obtain structures that are equivalent to coil antennas which are approximation to radially directed magnetic dipoles. These will be denoted as radial coil antennas in short. These structures may be used to obtain multi-component antennas as described before. The advantage of the described configurable structure, in addition to those previously mentioned, are its ease of manufacturing as well as the ability to switch between radial and axial configurations (or radial configurations oriented at a different azimuthal angle, preferably orthogonal to a first radial configuration), thus obtaining all the x-, y- and z-components of the measurements described in relation to Equation 2 using a single structure. Note that this would be an alternative to the tilted antenna implementation discussed above. In embodiments of the configurable antenna as shown in FIG. 7A, a voltage is applied between addends labeled as (+) and (−) and the addends shown as shaded are activated such that the shaded addends are excited and current flows in the direction indicated by the line from the (+) addend to (−) addend. This structure, when wrapped around a cylindrical structure would be equivalent to the traditional implementation shown in FIG. 7B using coil antennas.

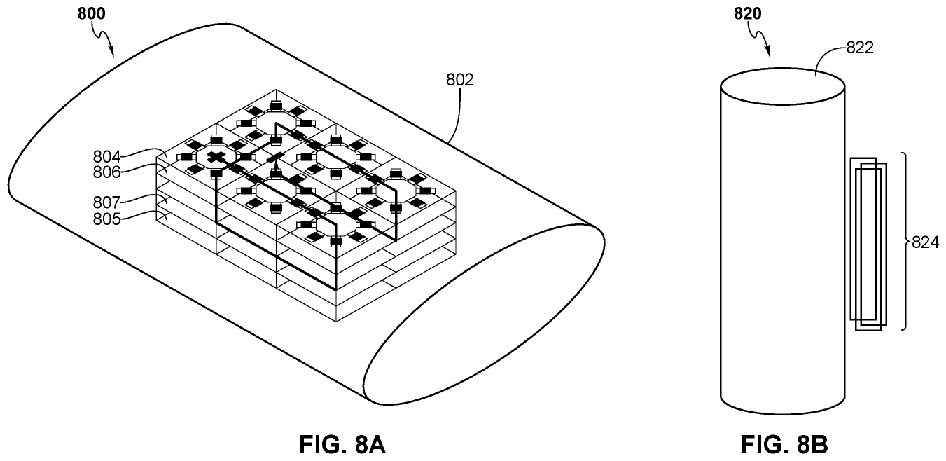

FIG. 8A illustrates a perspective view 800 of an electrically coupled antenna configuration configured to provide an antenna coil in accordance with various embodiments. FIG. 8B is a perspective view 820 representing an electrical equivalent of the antenna coil that the configuration of addends in FIG. 8A may be arranged to provide. As shown in FIG. 8A, a plurality of layers 804, 805, 806, and 807, each layer having a plurality of addends, may be arranged around a toroid body 802, wherein the addends included within the layers 804, 805, 806, and 807 may be coupled in a manner that form a set of coils extending around the toroid body 802.

When arranged as described above, the plurality of addends included in layers 804, 805, 806, and 807 and coupled together to form a toroid coil as described above with respect to FIG. 8A, when positioned along a tool body 822, in some embodiments having a cylindrical shape, form a set of antenna coils illustratively represented as antenna 824 in FIG. 8B. When configured as described in FIG. 8A and as arranged in FIG. 8B, the antenna 824 may be configured to have a waveform signal applied to the addends, and to therefore transmit a signal emanating from the antenna 824 formed by the arrangement of the addends. In addition, in the alternative or at different times, antenna 824 may be coupled to a receiver (not shown in FIG. 8A or 8B, but for example receiver circuitry 269, FIG. 2B), and configured to receive signals that arrive at the antenna 824.

Toroid transmitters can be thought of as sources of magnetic current which in turn creates a voltage across a toroid receiver. Data encoded in the current signal of the transmitting toroid may be received and encoded at the receiving transmitter, enabling the transmission of data. To enable data transmission across larger distances, short-hop data transmission may be utilized where data is transmitted across intermediate toroid sensors before reaching its final destination. In such cases, toroids may be built as transceivers (i.e., sensors acting as both transmitters and receivers).

In the toroid configurable antenna as shown in FIG. 8A, the addend denoted by (+) sign may be connected to the positive terminal of a power source in the transmitting mode (or may be connected to the positive terminal of a voltage sensing circuitry in the receiving mode) while the addend denoted by the (−) sign may be connected to the negative terminal of a power source in the transmitting mode (or may be connected to the negative terminal of a voltage sensing circuitry in the receiving mode). The addends shown as shaded in FIG. 8A between the two addends may be activated by turning on the connections along the path of the addends coupled together. Thus, a conducting structure that is equivalent to a toroid will be achieved. Equivalent structure using a traditional toroid would be as shown in FIG. 8B. This structure may be used to transmit data to/from the compartmental antenna. Data may be directly transmitted to a system control/data processing center, effectively replacing any other telemetry system. In other embodiments, data may be transmitted to the central telemetry system for further transmission. In the latter, the equivalent toroid transceiver would act as the final leg of the data transmission process, eliminating the need for a direct connection between the telemetry system and possibly many compartmental antennas that may be installed. Although the data to be transmitted is envisioned to have come to/from the compartmental antenna, it may also be possible to transmit data from other sensors that are connected to the compartmental antenna and the central telemetry system or the control center.

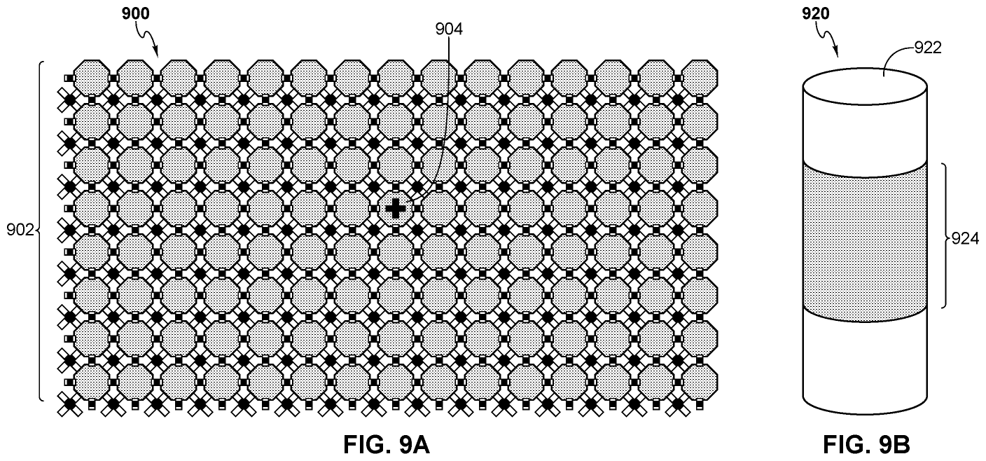

FIG. 9A illustrates a plan view 900 of an electrically coupled electrode configuration configured to provide an electrode equivalent in accordance with various embodiments. FIG. 9B is a perspective view 920 representing an electrical equivalent of the electrode that the configuration of addends in FIG. 9A may be arranged to provide. As shown in FIG. 9A, a single addend 904 is designated as the “+” addend. All of the addends 902 included in the electrode configuration are electrically coupled together, so that any voltage level and/or waveform applied to addend 904 is also present at each of the addends 902 included in the configurable electrode.

When arranged as described above, the addends 902 when wrapped around a tool body 922 having a cylindrical shape, form a single pole electrode that is illustratively represented as electrode 924 in FIG. 9B. When configured as described in FIG. 9A and as arranged in FIG. 9B, the electrode 924 may be configured to have a waveform signal applied to the addends, and to therefore transmit a signal emanating from the electrode 924 formed by the arrangement of the addends. In addition, in the alternative or at different times, electrode 924 may be coupled to a receiver (not shown in FIG. 9A or 9B, but for example receiver circuitry 269, FIG. 2B), and configured to receive signals that arrive at the electrode 924.

A monopole electrode may be obtained as shown in FIG. 9A. In various embodiments, the addend structure is formed on a flexible PCB, and in various embodiments, is wrapped around a cylindrical structure such as a mandrel, tool body, drill bit or the casing. Addends and connections of the configurable electrode may be etched on the flexible PCB as previously described. Addends shown as shaded in FIG. 9A are excited by connecting at least one of the addends to a power source. Addends and connections may be connected to the positive (+) voltage terminal of a power source, in which case the monopole would act as a transmitting electrode (i.e., a current source). Thus, current will be emitted from the excited addends into the medium surrounding the configurable electrode. In other implementations, addends may be connected to the negative (−) voltage terminal and then the monopole would act as a return electrode (i.e., a current sink). In yet other implementations, the configurable electrode of FIG. 9A may work as a passive monitor electrode wherein no connection to a power source exists but addends on the activated path are connected to a detector circuit to measure the voltage. Circuit components such as filters that attenuate the frequencies outside of the desired frequency range of the electrode, power amplifiers for transmitting a higher amount of current or low noise amplifiers for increasing the received signal may be connected to one or more addends as well. As previously mentioned, the other electrode(s) in the system may be other compartmental electrodes, traditional electrodes or a combination of both. For the case shown in FIG. 9A, all the addends are excited, and connections are activated, but in other cases only a subset may be turned on. This may allow the size of the electrode to be changed. A shorter electrode may provide a higher resolution, while a longer electrode may increase the signal-to-noise ratio (SNR), or may provide better focusing. Thus, depending on the job requirements, this trade-off may be optimized by reconfiguring the configurable electrode.

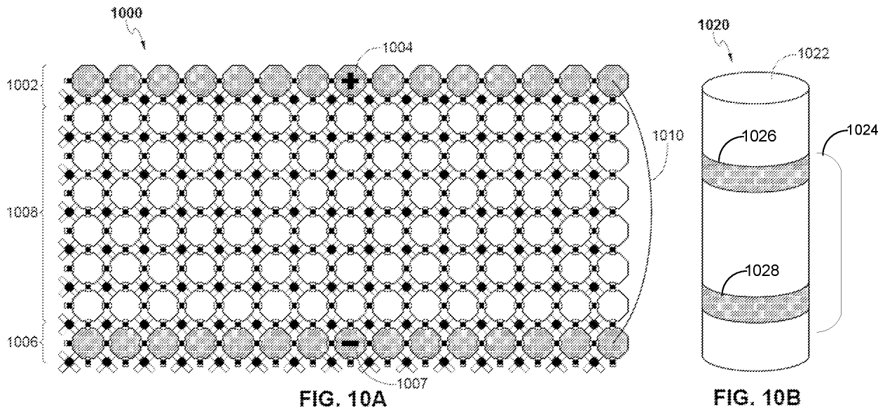

FIG. 10A illustrates a plan view 1000 of an electrically coupled electrode configuration configured to provide an electrode equivalent in accordance with various embodiments. FIG. 10B is a perspective view 1020 representing an electrical equivalent of the electrode that the configuration of addends in FIG. 10A may be arranged to provide. As shown in FIG. 10A, a first row of addends 1002 located as the top row in the electrode configuration includes a single addend 1004 designated as the “+” addend. A second row of addends 1006 configured as the bottom row of addends in the electrode configuration, and separated from the first row of addends by six rows of addends 1008. The second row of addends 1006 includes a single addend 1007 designated as the “−” addend. In various embodiments, electrode of FIG. 10A is configured to sense a parameter, such as a voltage level and/or a waveform applied to between addends 1004 and 1007, which may be sensed through a material, such as a formation material represented by line 1010. When configured as shown in FIG. 10A the configurable electrode is a dipole electrode.

When arranged as described above, the addends 1002, 1006, and 1008, when wrapped around a tool body 1022 having a cylindrical shape, form a dipole electrode that is illustratively represented as electrode 1024 in FIG. 10B. In various embodiments, electrode 1026 as shown in FIG. 10B corresponds to the set of addends included in row 1002 in FIG. 10A, and electrode 1028 as shown in FIG. 10B corresponds to the set of addends included in row 1006 in FIG. 10B. In various embodiments, in operation one of electrodes 1026, 1028 will be configured to transmit, and the other one of these electrodes will be configured to receive. When configured as described in FIG. 10A and as arranged in FIG. 10B, the electrode 1024 may be configured to have a waveform signal applied to the addends of rows 1002 and 1006, and to therefore transmit a signal emanating from the electrode 1024 formed by the arrangement of the addends. In addition, in the alternative or at different times, electrode 1024 may be coupled to a receiver (not shown in FIG. 10A or 10B, but for example receiver circuitry 269, FIG. 2B), and configured to receive signals that arrive at the electrode 1024.

In the most basic form of such an implementation as shown in FIG. 10A, a dipole electrode may be obtained using a single configurable electrode configuration. In the configuration shown in the FIG. 10A, it is assumed that the configurable electrode is wrapped around a cylindrical surface using a flexible PCB. Connections between a row of addends 1002 as well as the connection between one or more of these addends and the (+) terminal of a power source are activated, while at the same time connections between another row of addends 1006 on the same configurable electrode configuration as well as the connection between one or more of the addends and the (−) terminal of the power source are also activated. Thus, current will be transmitted from the addends connected to the (+) terminal and it will return to the addends connected to the (−) terminal, acting as an electric dipole. Although a single row of addends is used to obtain the electrodes in figure, in other implementations, length and width of the electrodes may be changed by changing the number of connected addends. Furthermore, more electrodes may be created in a single configurable electrode configuration depending on the needs of a particular job. Implementation of a dipole using traditional electrodes is shown in FIG. 10B.

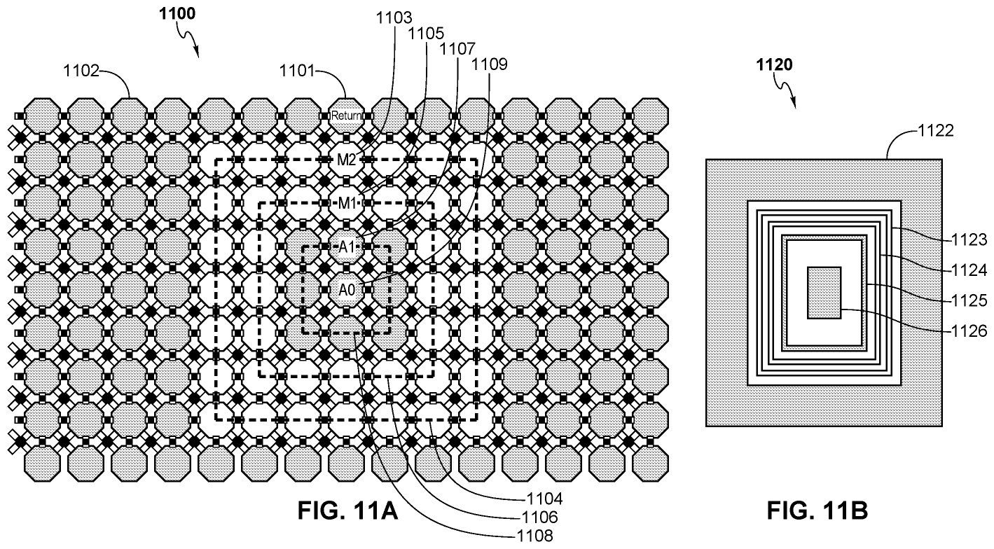

FIG. 11A illustrates a plan view 1100 of an electrically coupled electrode configuration configured to provide an electrode equivalent in accordance with various embodiments. FIG. 11B is a perspective view 1120 representing an electrical equivalent of the electrode that the configuration of addends in FIG. 11A may be arranged to provide.

When arranged as described as shown in FIG. 11A, the configurable antenna includes a single addend 1109, designated as “A0” is located at or near the center of the array of addends. A first ring of addends 1107, designated as “A1”, are electrically coupled to one another, and form a loop around addend 1109 (“A0”), as indicated by dashed box 1108, but are not directly coupled electrically to addend 1109 through any of the electrical switching devices directly coupled to addend 1109. A second ring of addends 1105, designates as “M1”, are electrically coupled to one another, and form a loop around the first loop of addends (“A1”), the second loop of addends indicated by dashed box 1106, but are not directly coupled electrically to addend A0 or to any of the addends included in the first loop through any of the electrical switching devices directly coupled to addend A0 or to the addends of the first loop. A third ring of addends 1103, designates as “M2”, are electrically coupled to one another, and form a loop around the second loop of addends (“M1”), the third loop of addends indicated by dashed box 1104, but are not directly coupled electrically to addend A0 or to any of the addends included in the first loop or the second loop through any of the electrical switching devices directly coupled to addend A0 or to the addends of the first loop or the second loop. In various embodiments, the set of addends 1101 remaining in the configurable antenna but not included in set of addends forming A0, A1, M1, and M2 are electrically coupled to one another to form a return electrode.

Embodiments of the configurable electrode as illustrated in FIG. 11A electrodes may also be used to obtain structures that are equivalent to a micro focused logging tool. In various embodiments, the configurable electrode sensor is mounted on a pad. In this embodiment as illustrated in FIG. 11B, a single addend 1126 is connected to the positive terminal of a power source to obtain the equivalent of current electrode A0 electrode of the MSFL configuration (rectangle 1126 in FIG. 11B). Addends coupled to addend 1107 and surrounding addend 1109, as indicated by dashed box 1108 (1125 in FIG. 11B), are also connected to the same terminal of the power source. Thus, these addends form the equivalent of the guard electrode, A1, of the MSFL. Addends indicated by dashed box 1106 (1124 in FIG. 11B), surrounding the guard electrode are not connected to any power source but they are connected to each other. This ring of addends serve as the first of the monitor electrodes, M1 of the MSFL tool. Similarly, another ring of passive addends that are connected to each other as indicated by dashed box 1104 (1123 in FIG. 11B), and with activated connections between each of these addends serving as the second monitor electrode, M2 of the MSFL tool. The ring surrounding the addends forming M2 is shown to constitute the return of the MSFL tool. The return electrode is represented by 1122 in FIG. 11B. Equivalent tool obtained using traditional electrodes is shown in FIG. 11B. Implementation depicted in FIG. 11A may illustrate a simplified case. In other implementations, there may be a larger number of addends that may allow the width of each electrode of the configurable electrode to be changed.

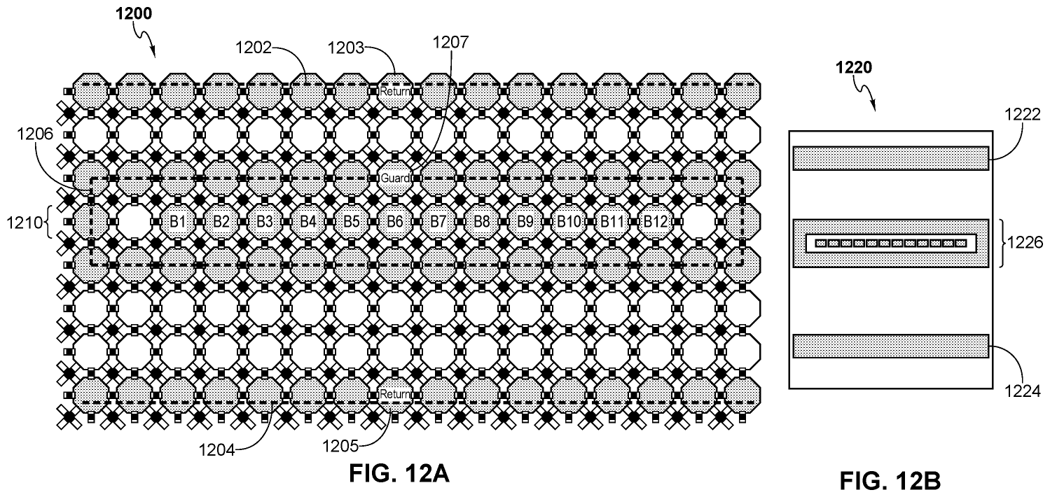

FIG. 12A illustrates a plan view 1200 of an electrically configurable electrode in accordance with various embodiments. FIG. 12B is a perspective view 1220 representing an electrical equivalent of the configurable electrode comprising the addends in FIG. 12A may be arranged to provide. As shown in FIG. 12A, a row of addends 1210 include individual addends B1-B12, surrounded by a set of addends, indicated by dashed box 1206, which forms a guard electrode 1207. A top row of addends, indicated by dashed line 1202, forms a first return electrode 1203, and a bottom row of addends, indicated by dashed line 1204, form a second return electrode 1205. The configurable electrode may be formed on a plate as shown in FIG. 12B, with the button assembly and guard electrode, indicated as row 1226, positioned between a first return electrode 1222 and a second return electrode 1224.

Embodiment of the configurable electrode of FIG. 12A may include implementations utilized in an oil-based mud resistivity imager tool. As noted above, resistivity imagers operating in water based muds will have similar designs, but they will operate at lower frequencies and will use galvanic principles instead of capacitive coupling required to overcome resistive mud for oil-based mud resistivity imager tools. Button electrodes are labeled as B1 through B12 in the figure and they consist of single addends. In alternative implementations, button electrodes may comprise of more than one addend to increase the signal to noise ratio. However, this will decrease the resolution of the tool. Although 12 button electrodes are shown in the figure, this number may be less or more depending on the requirements of a particular job as well as the constraints set by the number of addends present in the compartmental electrode. Button electrodes are surrounded by a guard electrode formed by a ring of addends with activated connections between them. Both the button and guard electrodes may be connected to a power source and may be held at the same potential. The other terminal of the power source may be connected to the return electrodes (again by activating connections between the terminal of the power source and the desired addends), for example through connections of addends 1203 and 1205. There are two return electrodes for symmetry, each of which are comprised of a strip of connected addends. Connection to addends of the button electrodes from the power source may be surrounded by toroid sensors to measure the amount of current transmitted. Thus, by taking the ratio of the voltage between the button/guard electrodes and return electrodes to the current of the button electrodes, an impedance may be calculated. This impedance may then be used to form an image as the tool moves in the borehole.

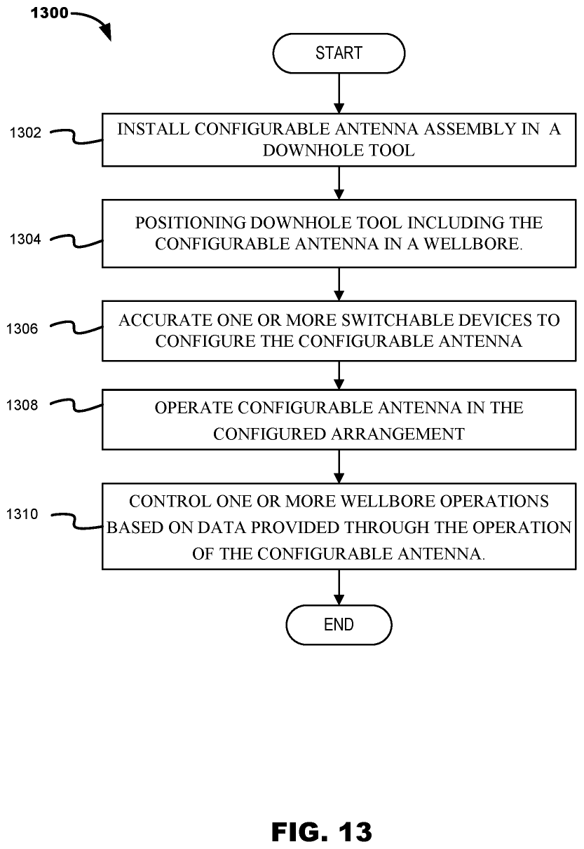

FIG. 13 illustrates a flowchart of a method 1300 in accordance with various embodiments. In various embodiments, method 1300 may be performed by some combination of the components illustrated and described above with respect to well system 100 and FIG. 1A and/or wireline system 160 and FIG. 1B. In various embodiments, method 1300 may be performed including the use of one or more embodiments of the configurable arrays of addends, as described throughout this disclosure and any equivalents thereof, to configure antennas and/or electrodes for use in a wellbore environment such as a borehole. While the configurable array of addends is described below with respect to method 1300 as representing a configurable antenna or a configurable antenna assembly, the method 1300 applies equally to the configurable electrodes and/or the configurable electrode assemblies as described throughout this disclosure, and any equivalents thereof.

As shown in FIG. 13, embodiments of method 1300 include installing a configurable antenna assembly in a downhole tool (block 1302). The configurable antenna may comprise any of the configurable antennas having a plurality of addends that are controllably couplable as described throughout this disclosure. The configurable antenna assembly may include an antenna controller, such as addends configuration controller 260 (FIG. 2B), which may include some combination or all of the components comprising a power supply, an addend controller, a switch controller, a signal generator, and receiver circuitry.

Embodiments of method 1300 include positioning the downhole tool including the configurable antenna, in a downhole location within a wellbore (block 1304).

Embodiments of method 1300 include actuating one or more switchable devices configured to couple the addends included in the configurable antenna to configure the configurable antenna into a particular antenna configuration (block 1306). In various embodiments, configuring the configurable antenna includes providing an actuation signal to each of a number of switching devices included in the configurable antenna, wherein one or more of the actuation signals are configured in order to switch the switching devices to an “ON” state and thereby electrically couple a set of the addends included within the configurable antenna in order to form a particular antenna configuration based on the electrical coupling of the set of addends.

Embodiments of method 1300 include operating the configurable antenna in the configured arrangement (block 1308). In various embodiments, operating the configurable antenna in the configurable arrangement includes applying a signal having a waveform to the configurable antenna in order to have the signal emanate and be transmitted from the configurable antenna. In various embodiments, operating the configurable antenna in the configured arrangement includes receiving a signal having a waveform at the antenna, and providing the received signal to a receiver circuitry for further processing. When operated in an electrode configuration, the configuration of addends may be used to sense parameters such as electrical voltages and resistivity levels at various locations within a wellbore.

Embodiments of method 1300 include controlling one or more wellbore operations based on information obtained as a result of operating the configurable antenna within the wellbore (block 1310). Controlling one or more wellbore operation may include any control needed during a drilling operation, such as controlling weight-on-bit, rate of drill bit rotation, flow rate and/or composition of the drilling fluid being provided to the drill bit. Controlling one or more wellbore operations as part of a production operation may include any control related to the pumping, operation of packers, or other control operations needed to provide proper and safe production at the wellbore.

FIG. 14 illustrates a block diagram of an example computing system 1400 that may be employed to practice the concepts, methods, and techniques as disclosed herein, and variations thereof. Computing system 1400 includes a plurality of components of the system that are in electrical communication with each other, in some examples using a bus 1403. Embodiments of computing system 1400 may include any suitable computer, micro-controller, or data processing apparatus capable of being programmed to carry out the methods and for controlling apparatus as described herein. In various embodiments, one or more components illustrated and described with respect to computing system 1400 may be included in user interface 150 and/or downhole computer system 130 as illustrated and described above with respect to FIG. 1A, and/or included in downhole tool 184 as illustrated and described with respect to FIG. 1B. In various embodiments, one or more components illustrated and described with respect to computing system 1400 may be included in the addends configuration controller 260 as illustrated and described with respect to FIG. 2B.

Referring back to FIG. 14, computing system 1400 may be a general-purpose computer, and includes a processor 1401 (possibly including multiple processors, multiple cores, multiple nodes, and/or implementing multi-threading, etc.). The computing system 1400 includes memory 1402. The memory 1402 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the possible realizations of machine-readable media configured to store data and/or program instructions in an electronic format. The computer system also includes the bus 1403 (e.g., PCI, ISA, PCI-Express, HyperTransport® bus, InfiniBand® bus, NuBus, etc.) and a network interface 1405 (e.g., a Fiber Channel interface, an Ethernet interface, an internet small computer system interface, SONET interface, wireless interface, etc.). Bus 1403 may be configured to provide communications between any of the devices included in computing system 1400. As illustrated in FIG. 14, the processor 1401 and the network interface 1405 are coupled to the bus 1403. Although illustrated as also being coupled to the bus 1403, the memory 1402 may be coupled to the processor 1401 only, or both processor 1401 and bus 1403. In some examples, memory 1402 includes non-volatile memory and can be a hard disk or other types of computer readable media which can store data and program instructions that are accessible by a computer, such as magnetic cassettes, flash memory cards, solid state memory devices, digital versatile disks (DVDs), cartridges, RAM, ROM, a cable containing a bit stream, and hybrids thereof. Network interface 1405 may be configured to provide communications between computing system 1400 and other computing devices.

Embodiments of computing system 1400 include addends configuration controller 1407 (hereinafter “controller 1407”). In various embodiments, controller 1407 is coupled to bus 1403, and may be configured to perform any of the functions and to provide any of the features described above with respect to addends configuration controller 260 (FIG. 2B). For example, controller 1407 may include a power supply, an addend controller, and a switch controller. The power supply is configured to provide electrical power needed to operate the addend controller and the switch controller. The switch controller is configured to operate a set of switch control lines coupled to a set of switching devices, such as switching devices 205 (FIG. 2A), which control the electrical connections (or disconnections) between addends in one or more configurable antenna(s) and/or one or more configurable electrode(s) 1409. The controller 1407 is configured to provide a status to each of the addends in the one or more configurable antenna(s) and/or one or more configurable electrode(s), and to provide inputs signals generated by a signal generator (signal generator 268, FIG. 2B) and/or to receive signals that have be received at the one or more configurable antenna(s) and/or one or more configurable electrode(s) 1409, and for received signals to pass the received signals on to receiver circuitry (receiver circuitry 269, FIG. 2B) for further processing.

In various embodiments, programming stored in memory 1402 and operated on by processor 1401 is configured to control the operation of the addends configuration controller 1407, and thus control the configuration and operation of the one or more configurable antenna(s) and/or one or more configurable electrode(s) 1409. In various embodiments, network interface 1405 is configured to receive instruction from one or more devices other than computer system 1400, the instructions related to the operation of addends configuration controller 1407 and the configuration and/or operation of the one or more configurable antenna(s) and/or one or more configurable electrode(s) 1409, including information relate to the signals to be provided to and thus emanating as transmissions from the one or more configurable antenna(s) and/or one or more configurable electrode(s) 1409. In various embodiments, information associated with signals received at the one or more configurable antenna(s) and/or one or more configurable electrode(s) 1409 are processed by receiver circuitry included in addends configuration controller 1407 and made available to processor 1401 for further processing, for storage in memory 1402, and/or for transmission to one or more other devices outside of computer system 1400 using network interface 1405.

It will be understood that one or more blocks of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus. As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine. While depicted as a computing system 1400 or as a general purpose computer, some embodiments can be any type of device or apparatus to perform operations described herein.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, which employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

While the aspects of the disclosure are described with reference to various implementations and exploitations, it will be understood that these aspects are illustrative and that the scope of the claims is not limited to them. In general, techniques for electrically configuring antennas and/or electrodes as described herein may be implemented with facilities consistent with any hardware system or hardware/software systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

Example embodiments include the following.

Embodiment 1. An apparatus comprising: a configurable antenna for use as part of a downhole tool positioned within a wellbore, the configurable antenna comprising a plurality of addends, each one of the addends formed from a pad of electrically conductive material, the plurality of addends arranged in an array, wherein each of the plurality of addends is directly coupled to one or more adjacent addends within the array, each pair of adjacent addends within the array directly coupled through a respective pair of electrical conductors and a corresponding switchable electrical device; wherein the corresponding switchable electrical device is configured to be electrically controllable to electrically connect and disconnect the pair of adjacent addends couple d through the corresponding switchable electrical device and the pair of the electrical conductors, and wherein the set of switchable electrical devices are configured to be electrically controllable to form an electrically connected set of the plurality of addends arranged to form the configurable antenna.

Embodiment 2. The apparatus of embodiment 1, wherein the electrically conductive material forming the pad of each of the plurality of addends comprises copper metal.

Embodiment 3. The apparatus of embodiments 1 or 2, wherein the set of electrical conductors is formed as traces formed on a printed circuit board, the traces comprising copper metal.

Embodiment 4. The apparatus of any one of embodiments 1-3, wherein the set of switchable devices comprises individually controllable transistors.

Embodiment 5. The apparatus of any one of embodiments 1-4, wherein each of the electrically switchable devices is electrically coupled through an individual switch control line to a switch controller, the switch controller configured to provide a set of control signals to the individual switch control lines to control the electrical connections between each of the pairs of adjacent addends.

Embodiment 6. The apparatus of any one of embodiments 1-5, wherein each of the plurality of addends is electrically coupled through an individual addend control line to an addend controller, the addend controller configured to set a status of the addend by either applying a signal to the addend, floating the addend so the addend line disconnects the addend coupled to the control line from any additional circuitry within the addend controller, or coupling the addend as a return or a ground connection.

Embodiment 7. The apparatus of any one of embodiments 1-6, wherein the addends are located in a flexible layer of material configured to allow the antenna configuration to bend around and be formed to the shape of an outer surface of the downhole tool.

Embodiment 8. The apparatus of any one of embodiments 1-7, wherein the set of switchable electrical devices are configured to be electrically controllable to form an electrically connected set of the plurality of addends arranged to form an antenna comprising a set of antenna coils.

Embodiment 9. The apparatus of any one of embodiments 1-7, wherein the set of switchable electrical devices are configured to be electrically controllable to form an electrically connected set of the plurality of addends arranged to form an antenna comprising a set of tilted antenna coils.

Embodiment 10. The apparatus of any one of embodiments 1-7, wherein the set of switchable electrical devices are configured to be electrically controllable to form an electrically connected set of the plurality of addends arranged to form an antenna comprising a radial coil antenna.

Embodiment 11. The apparatus of any one of embodiments 1-7, wherein the set of switchable electrical devices are configured to be electrically controllable to form an electrically connected set of the plurality of addends arranged to form an antenna comprising a toroid antenna.

Embodiment 12. The apparatus of any one of embodiments 1-7, wherein the set of switchable electrical devices are configured to be electrically controllable to form an electrically connected set of the plurality of addends arranged to form an antenna comprising a monopole electrode.

Embodiment 13. The apparatus of any one of embodiments 1-7, wherein the set of switchable electrical devices are configured to be electrically controllable to form an electrically connected set of the plurality of addends arranged to form an antenna comprising a dipole electrode.

Embodiment 14. The apparatus of any one of embodiments 1-7, wherein the set of switchable electrical devices are configured to be electrically controllable to form an electrically connected set of the plurality of addends arranged to form an antenna comprising micro focused logging tool.

Embodiment 15. The apparatus of any one of embodiments 1-7, wherein the set of switchable electrical devices are configured to be electrically controllable to form an electrically connected set of the plurality of addends arranged to form an antenna comprising resistivity imager tool.

Embodiment 16. A method comprising: positioning a downhole tool within a wellbore, the downhole tool including a configurable antenna comprising: a plurality of addends, each one of the addends formed from a pad of electrically conductive material, the plurality of addends arranged in an array, wherein each of the plurality of addends is directly coupled to one or more adjacent addends within the array, each pair of adjacent addends within the array directly coupled through a respective pair of electrical conductors and a corresponding switchable electrical device, wherein the corresponding switchable electrical device is configured to be electrically controllable to electrically connect and disconnect the pair of adjacent addends coupled through the corresponding switchable electrical device and the pair of the electrical conductors, and wherein the set of switchable electrical devices are configured to be electrically controllable to form an electrically connected set of the plurality of addends arranged to form the configurable antenna; actuating one or more switchable devices within the antenna to configure an electrically coupled set of addends of the plurality of addends, the electrically coupled set of addends forming a configurable antenna; and operating the configurable antenna in the configurated arrangements of electrically coupled addends in order to transmit or receive signals within the wellbore.

Embodiment 17. The method of embodiment 16, wherein operating the configurable antenna in the configured arrangement comprises applying an electronic signal generated by a signal generator couple to the configurable antenna so that the configurable antenna transmits a signal emitted from the configurable antenna.

Embodiment 18. The method of embodiment 16, wherein operating the configurable antenna in the configured arrangement comprises receiving at the configurable antenna an electrical signal, and coupling the received electrical signal to a receiver circuitry that is coupled to the configurable antenna.

Embodiment 19. A non-transitory machine readable medium containing program instructions executable by a processor to perform the functions of: controlling the actuation one or more switchable devices within a configurable antenna to configure an electrically coupled set of addends of a plurality of addends arranged in an array, the electrically coupled set of addends forming a configurable antenna for use in a downhole tool positioned within a wellbore, wherein, each one of the addends of the plurality of addends is formed from a pad of electrically conductive material, the plurality of addends arranged in an array, and wherein each of the plurality of addends is directly coupled to one or more adjacent addends within the array, each pair of adjacent addends within the array directly coupled through a respective pair of electrical conductors and a corresponding switchable electrical device

Embodiment 20. The non-transitory machine readable medium of embodiment 19, wherein the program instruction further include instruction executable by the processor to perform the functions of: operating the configurable antenna in a first mode by controlling the application of an electronic signal generated by a signal generator couple to the configurable antenna so that the configurable antenna transmits a signal emitted from the configurable antenna in a first mode, and operating the configurable antenna in a second mode by controlling the coupling and further processing of an electrical signal received at the configurable antenna utilizing a receiver circuitry that is coupled to the configurable antenna.

What is claimed is:

1. An apparatus comprising:
a configurable antenna for use as part of a downhole tool positioned within a wellbore, the configurable antenna comprising a plurality of addends, each one of the addends formed from a pad of electrically conductive material, the plurality of addends arranged in an array, wherein each of the plurality of addends is directly coupled to one or more adjacent addends within the array, each pair of adjacent addends within the array directly coupled through a respective pair of electrical conductors and a corresponding switchable electrical device;
wherein the corresponding switchable electrical device is configured to be electrically controllable to electrically connect and disconnect the pair of adjacent addends coupled through the corresponding switchable electrical device and the pair of the electrical conductors, and
wherein the set of switchable electrical devices are configured to be electrically controllable to form an electrically connected set of the plurality of addends arranged to form the configurable antenna.

2. The apparatus of claim 1, wherein the electrically conductive material forming the pad of each of the plurality of addends comprises copper metal.

3. The apparatus of claim 1, wherein the set of electrical conductors is formed as traces formed on a printed circuit board, the traces comprising copper metal.

4. The apparatus of claim 1, wherein the set of switchable devices comprises individually controllable transistors.

5. The apparatus of claim 1, wherein each of the electrically switchable devices is electrically coupled through an individual switch control line to a switch controller, the switch controller configured to provide a set of control signals to the individual switch control lines to control the electrical connections between each of the pairs of adjacent addends.

6. The apparatus of claim 1, wherein each of the plurality of addends is electrically coupled through an individual addend control line to an addend controller, the addend controller configured to set a status of the addend by either applying a signal to the addend, floating the addend so the addend line disconnects the addend coupled to the control line from any additional circuitry within the addend controller, or coupling the addend as a return or a ground connection.

7. The apparatus of claim 1, wherein the addends are located in a flexible layer of material configured to allow the antenna configuration to bend around and be formed to the shape of an outer surface of the downhole tool.

8. The apparatus of claim 1, wherein the set of switchable electrical devices are configured to be electrically controllable to form an electrically connected set of the plurality of addends arranged to form an antenna comprising a set of antenna coils.

9. The apparatus of claim 1, wherein the set of switchable electrical devices are configured to be electrically controllable to form an electrically connected set of the plurality of addends arranged to form an antenna comprising a set of tilted antenna coils.

10. The apparatus of claim 1, wherein the set of switchable electrical devices are configured to be electrically controllable to form an electrically connected set of the plurality of addends arranged to form an antenna comprising a radial coil antenna.

11. The apparatus of claim 1, wherein the set of switchable electrical devices are configured to be electrically controllable to form an electrically connected set of the plurality of addends arranged to form an antenna comprising a toroid antenna.

12. The apparatus of claim 1, wherein the set of switchable electrical devices are configured to be electrically controllable to form an electrically connected set of the plurality of addends arranged to form an antenna comprising a monopole electrode.

13. The apparatus of claim 1, wherein the set of switchable electrical devices are configured to be electrically controllable to form an electrically connected set of the plurality of addends arranged to form an antenna comprising a dipole electrode.

14. The apparatus of claim 1, wherein the set of switchable electrical devices are configured to be electrically controllable to form an electrically connected set of the plurality of addends arranged to form an antenna comprising micro focused logging tool.

15. The apparatus of claim 1, wherein the set of switchable electrical devices are configured to be electrically controllable to form an electrically connected set of the plurality of addends arranged to form an antenna comprising resistivity imager tool.

16. A method comprising:
positioning a downhole tool within a wellbore, the downhole tool including a configurable antenna comprising:
a plurality of addends, each one of the addends formed from a pad of electrically conductive material, the plurality of addends arranged in an array, wherein each of the plurality of addends is directly coupled to one or more adjacent addends within the array, each pair of adjacent addends within the array directly coupled through a respective pair of electrical conductors and a corresponding switchable electrical device,
wherein the corresponding switchable electrical device is configured to be electrically controllable to electrically connect and disconnect the pair of adjacent addends coupled through the corresponding switchable electrical device and the pair of the electrical conductors, and
wherein the set of switchable electrical devices are configured to be electrically controllable to form an electrically connected set of the plurality of addends arranged to form the configurable antenna;
actuating one or more switchable devices within the antenna to configure an electrically coupled set of addends of the plurality of addends, the electrically coupled set of addends forming a configurable antenna; and
operating the configurable antenna in the configurated arrangements of electrically coupled addends in order to transmit or receive signals within the wellbore.

17. The method of claim 16, wherein operating the configurable antenna in the configured arrangement comprises applying an electronic signal generated by a signal generator couple to the configurable antenna so that the configurable antenna transmits a signal emitted from the configurable antenna.

18. The method of claim 16, wherein operating the configurable antenna in the configured arrangement comprises receiving at the configurable antenna an electrical signal, and coupling the received electrical signal to a receiver circuitry that is coupled to the configurable antenna.

19. A non-transitory machine readable medium containing program instructions executable by a processor to perform the functions of:
controlling the actuation one or more switchable devices within a configurable antenna to configure an electrically coupled set of addends of a plurality of addends arranged in an array, the electrically coupled set of addends forming a configurable antenna for use in a downhole tool positioned within a wellbore,
wherein, each one of the addends of the plurality of addends is formed from a pad of electrically conductive material, the plurality of addends arranged in an array, and
wherein each of the plurality of addends is directly coupled to one or more adjacent addends within the array, each pair of adjacent addends within the array directly coupled through a respective pair of electrical conductors and a corresponding switchable electrical device.

20. The non-transitory machine readable medium of claim 19, wherein the program instruction further include instruction executable by the processor to perform the functions of:
operating the configurable antenna in a first mode by controlling the application of an electronic signal generated by a signal generator couple to the configurable antenna so that the configurable antenna transmits a signal emitted from the configurable antenna in a first mode, and
operating the configurable antenna in a second mode by controlling the coupling and further processing of an electrical signal received at the configurable antenna utilizing a receiver circuitry that is coupled to the configurable antenna.
